(19) United States
(12) Patent Application Publication
(10) Pub. No.: US 2026/0030791 A1
(43) Pub. Date: Jan. 29, 2026

(54) SCORE BASED FINE-GRAINED CONTROL OF CONCEPT GENERATION

(71) Applicant: ADOBE INC., SAN JOSE, CA (US)

(72) Inventors: Pranav Vineet Aggarwal, Santa Clara, CA (US); Aashish Kumar Misraa, Santa Clara, CA (US); Midhun Harikumar, Sunnyvale, CA (US); Jing Shi, San Jose, CA (US); He Zhang, Santa Clara, CA (US); Wei Xiong, San Jose, CA (US)

(21) Appl. No.: 18/785,914

(22) Filed: Jul. 26, 2024

(51) Int. Cl. G06T 11/00; G06F 40/40; G06T 5/70

(52) U.S. Cl. CPC G06T 11/00; G06F 40/40; G06T 5/70; G06T 2207/20081

(57) ABSTRACT

A method, apparatus, non-transitory computer readable medium, and system for image generation include obtaining an input prompt, a reference image, and a transform input. The input prompt describes a scene, the reference image depicts an object, and the transform input indicates a target level of a transformation for the object. An object embedding is generated, using an object encoder of an image generation model, based on the reference image and the transform input. The object embedding represents the object and the target level of the transformation. A synthetic image is generated, using the image generation model, based on the input prompt and the object embedding. The synthetic image depicts the object in the scene from the input prompt with the target level of the transformation.

### BACKGROUND

The following relates generally to image processing, and more specifically to image generation using machine learning. Digital image processing refers to the use of a computer to edit a digital image using an algorithm or a processing network. In some cases, image processing software can be used for various tasks, such as image editing, image restoration, image generation, etc. Recently, machine learning models have been used in advanced image processing techniques. Among these machine learning models, diffusion models and other generative models such as generative adversarial networks (GANs) have been used for various tasks including generating images with perceptual metrics, generating images in conditional settings, image inpainting, and image manipulation.

Image generation, a subfield of image processing, involves the use of diffusion models to synthesize images. Diffusion models can be used for various image generation tasks including image super-resolution, generation of images with perceptual metrics, conditional generation (e.g., generation based on text guidance), image inpainting, and image manipulation. Specifically, diffusion models are trained to take random noise as input and generate unseen images with features similar to the training data.

### SUMMARY

The present disclosure describes systems and methods for image generation. Embodiments of the present disclosure include an image generation apparatus that receives an input prompt, a reference image, and a transform input. The image generation apparatus performs score-based image generation using an object encoder. The object encoder is trained to take a transform input and a reference image depicting a concept as input. In some examples, the transform input includes a size parameter, an identity parameter, or both. In some examples, the transform input includes an identity score and a surface area score. The object encoder is trained to generate an object embedding which represents a target level of the transformation. The identity score guides a diffusion model to generate images preserving the identity of the target object in the reference image (e.g., overall identity, pose and view angle of the object). The surface area score guides the diffusion model to control the size of the main object in relation to the background.

A method, apparatus, and non-transitory computer readable medium for image generation are described. One or more embodiments of the method, apparatus, and non-transitory computer readable medium include obtaining an input prompt, a reference image, and a transform input, wherein the input prompt describes a scene, the reference image depicts an object, and the transform input indicates a target level of a transformation for the object; generating, using an object encoder of an image generation model, an object embedding based on the reference image and the transform input, wherein the object embedding represents the object and the target level of the transformation; and generating, using the image generation model, a synthetic image based on the input prompt and the object embedding, wherein the synthetic image depicts the object in the scene from the input prompt with the target level of the transformation.

A method, apparatus, and non-transitory computer readable medium for image generation are described. One or more embodiments of the method, apparatus, and non-transitory computer readable medium include obtaining a training set including a training input image, a training target image, and a training transform input, wherein the training target image depicts an object from the training input image with a target level of a transformation indicated by the training transform input and training, using the training set, an image generation model to generate an object embedding that represents the object with the target level of the transformation and to generate a synthetic image based on the object embedding, wherein the synthetic image depicts the object with the target level of the transformation.

An apparatus and method for image generation are described. One or more embodiments of the apparatus and method include at least one processor; at least one memory including instructions executable by the at least one processor; and an image generation model comprising parameters stored in the at least one memory and trained to receive an input prompt, a reference image, and a transform input, wherein the input prompt describes a scene, the reference image depicts an object, and the transform input indicates a target level of a transformation for the object, to generate an object embedding based on the reference image and the transform input, wherein the object embedding represents the object and the target level of the transformation, and to generate a synthetic image based on the input prompt and the object embedding, wherein the synthetic image depicts the object in the scene from the input prompt with the target level of the transformation.

### BRIEF DESCRIPTION OF THE DRAWINGS

FIG. 1 shows an example of an image generation system according to aspects of the present disclosure.

FIG. 2 shows an example of a method for conditional media generation according to aspects of the present disclosure.

FIG. 3 shows an example of concept based image synthesis according to aspects of the present disclosure.

FIG. 4 shows an example of identity score effect according to aspects of the present disclosure.

FIG. 5 shows an example of surface area score effect according to aspects of the present disclosure.

FIGS. 6 and 7 show examples of score based effect with both scores according to aspects of the present disclosure.

FIG. 8 shows an example of a method for image generation according to aspects of the present disclosure.

FIG. 9 shows an example of an image generation apparatus according to aspects of the present disclosure.

FIG. 10 shows an example of an image generation model according to aspects of the present disclosure.

FIG. 11 shows an example of an object encoder of an image generation model according to aspects of the present disclosure.

FIG. 12 shows an example of a latent diffusion model according to aspects of the present disclosure.

FIG. 13 shows an example of U-Net according to aspects of the present disclosure.

FIG. 14 shows an example of diffusion process according to aspects of the present disclosure.

FIGS. 15 and 16 show examples of methods for training a machine learning model according to aspects of the present disclosure.

FIG. 17 shows an example of training a diffusion model according to aspects of the present disclosure.

FIG. 18 shows an example of training a machine learning model according to aspects of the present disclosure.

FIG. 19 shows an example of preliminary training images according to aspects of the present disclosure.

FIG. 20 shows an example of dataset according to aspects of the present disclosure.

FIG. 21 shows an example of a distribution chart according to aspects of the present disclosure.

FIG. 22 shows an example of a computing device for image generation according to aspects of the present disclosure.

### DETAILED DESCRIPTION

The present disclosure describes systems and methods for image generation. Embodiments of the present disclosure include an image generation apparatus that receives an input prompt, a reference image, and a transform input. The image generation apparatus performs score-based image generation using an object encoder. The object encoder is trained to take a transform input and a reference image depicting a concept as input. In some examples, the transform input includes a size parameter, an identity parameter, or both. In some examples, the transform input includes an identity score and a surface area score. The object encoder is trained to generate an object embedding which represents a target level of the transformation. The identity score guides a diffusion model to generate images preserving the identity of the target object in the reference image (e.g., overall identity, pose and view angle of the object). The surface area score guides the diffusion model to control the size of the main object in relation to the background.

Diffusion models are a class of generative neural networks that can be trained to generate new data with features similar to features found in training data. Diffusion models can be used in image synthesis, image completion tasks, etc. Conventional text-to-image generation models estimate the size and amount of identity preservation for concept without control. These models are often biased due to the training set being used. Conventional models lack fine-grained control over the amount of similarity to the target object (concept) and the size of an object in relation to the background of an image.

Embodiments of the present disclosure include an image generation apparatus configured to obtain an input prompt, a reference image, and a transform input. The input prompt describes a scene, the reference image depicts an object, and the transform input indicates a target level of a transformation for the object. In some examples, the transform input includes an identity score, a surface area score, or both.

An object encoder of an image generation model generates an object embedding based on the reference image and the transform input. The object embedding represents the object and the target level of the transformation. The image generation model generates a synthetic image based on the input prompt and the object embedding. The synthetic image depicts the object in the scene from the input prompt with the target level of the transformation.

In some embodiments, an object encoder includes an identity positional layer, an area positional layer, an identity projection layer, an area projection layer, a projection layer, and a transformer encoder. In some cases, the object encoder includes an identity encoder (e.g., DINO encoder) that generates an identity embedding based on the reference image. The identity projection layer generates an identity projected embedding. The area projection layer generates an area projected embedding. The identity projected embedding, the area projected embedding, and the identity embedding are concatenated to obtain a concatenated embedding. The object encoder generates an object embedding based on the concatenated embedding.

The present disclosure describes systems and methods that improve on conventional image generation models by generating synthetic images that depict a target object more accurately. For example, users can obtain synthetic images with an object that is similar to the identity of a target object (concept) from a reference image. Embodiments of the present disclosure achieve this improved accuracy by training an object encoder that takes one or more transform parameters as input. The transform parameter indicates how much of a specified transformation to apply. For example, the transform input can include a level of transformation of size parameter, an identity parameter, or both. Accordingly, quality and accuracy of synthetic images are improved.

Additionally, systems and methods described in the present disclosure improve on conventional image generation models by providing increased controllability over concept based image generation. For example, an identity score is provided to control a level of similarity between an object in the synthetic image and a target object in the reference image (e.g., view, pose). A surface area score is provided to indicate a size of an object in the synthetic image in relation to the background of the synthetic image (e.g., a size of an object “dog” becomes larger in size in synthetic images when its surface area score changes from 0.1 to 0.9). This way, users gain controllability over image generation via score based fine-grained control methods described herein.

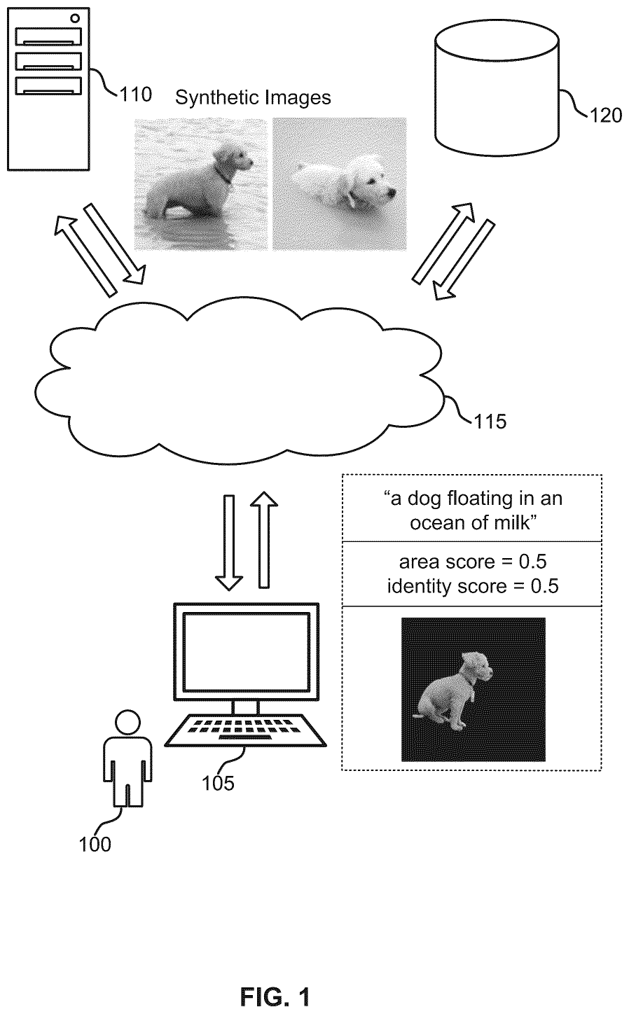

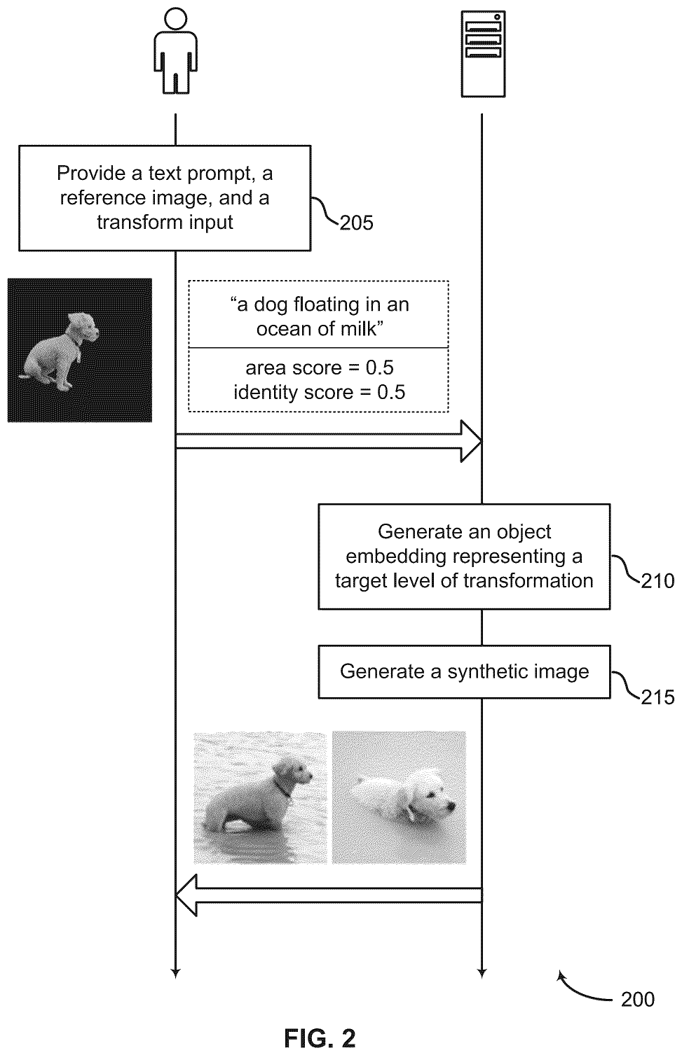

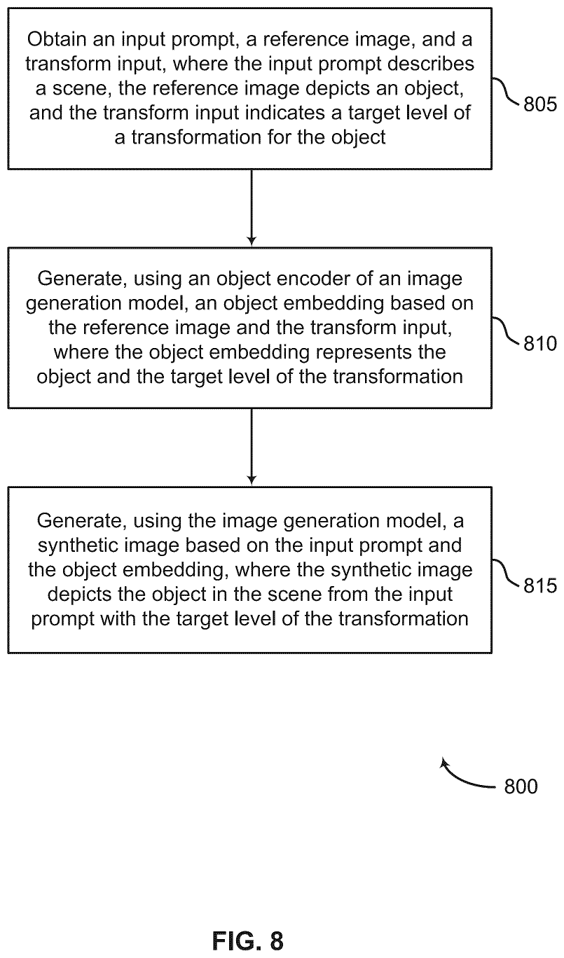

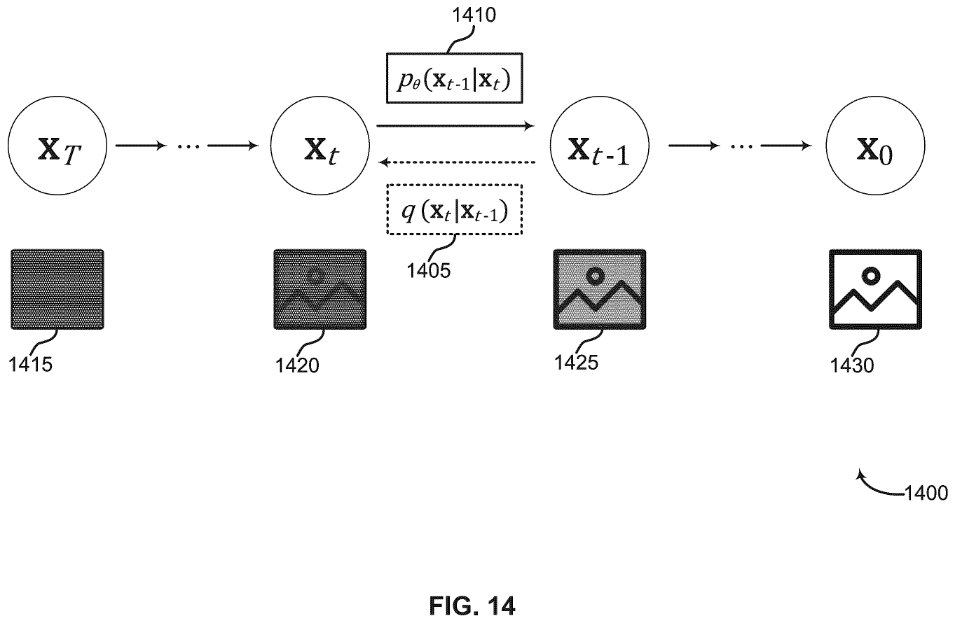

Examples of application in concept based image generation context are provided with reference to FIGS. 2-7. Details regarding the architecture of an example image generation system are provided with reference to FIGS. 1 and 9-13. Details regarding the image generation process are provided with reference to FIGS. 8 and 14. Details regarding an example of training an image generation model are provided with reference to FIGs. and 15-18.

### Scored-Based Image Generation

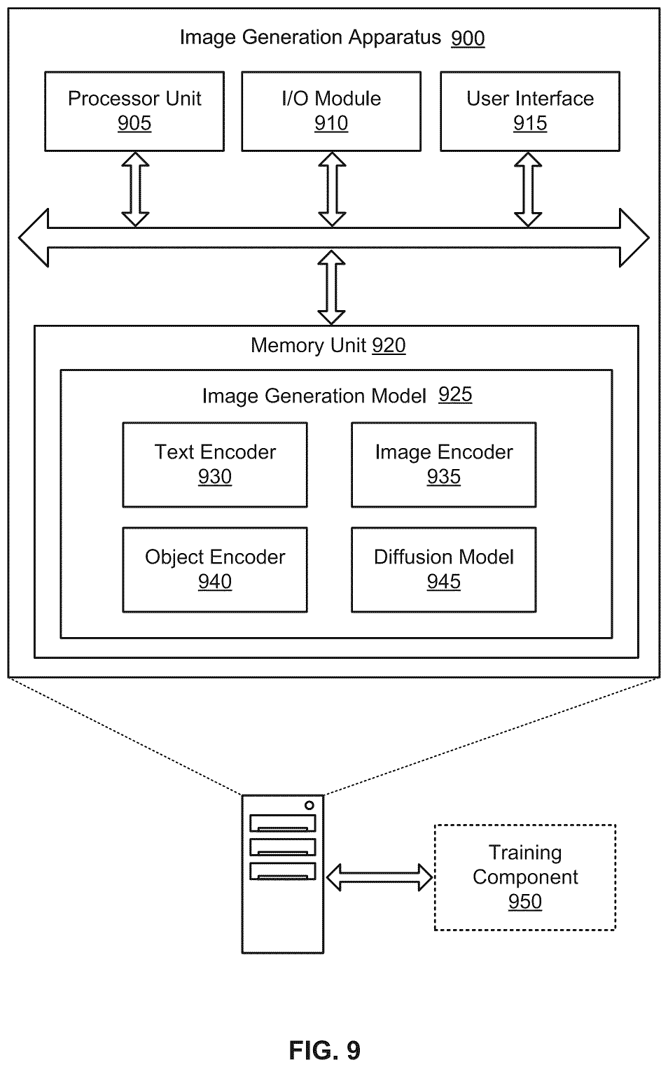

FIG. 1 shows an example of an image generation system according to aspects of the present disclosure. The example shown includes user 100, user device 105, image generation apparatus 110, cloud 115, and database 120. Image generation apparatus 110 is an example of, or includes aspects of, the corresponding element described with reference to FIG. 9.

In an example shown in FIG. 1, an input prompt is provided by user 100. For example, the input prompt is “a dog floating in ocean of milk”. User 100 may provide and set a surface area score to 0.5 and set an identity score to 0.5. User 100 uploads a reference image indicating a target object (e.g., the foreground “dog” on a black background). The input prompt, transform input (surface area score and identity score) and the reference image are transmitted to image generation apparatus 110, e.g., via user device 105 and cloud 115. The transform input indicates a target level of a transformation for the object.

Image generation apparatus 110 generates, using an object encoder of an image generation model, an object embedding based on the reference image and the transform input. The object embedding represents the object and the target level of the transformation. Image generation apparatus 110 generates, using the image generation model, a synthetic image based on the input prompt and the object embedding. The synthetic image depicts the object in the scene from the input prompt with the target level of the transformation. Image generation apparatus 110 returns one or more synthetic images to user 100 via cloud 115 and user device 105.

User device 105 may be a personal computer, laptop computer, mainframe computer, palmtop computer, personal assistant, mobile device, or any other suitable processing apparatus. In some examples, user device 105 includes software that incorporates an image processing application (e.g., an image generator, an image editing tool). In some examples, the image processing application on user device 105 may include functions of image generation apparatus 110.

A user interface may enable user 100 to interact with user device 105. In some embodiments, the user interface may include an audio device, such as an external speaker system, an external display device such as a display screen, or an input device (e.g., a remote control device interfaced with the user interface directly or through an I/O controller module). In some cases, a user interface may be a graphical user interface (GUI). In some examples, a user interface may be represented in code which is sent to the user device 105 and rendered locally by a browser.

Image generation apparatus 110 includes a computer-implemented network comprising a text encoder, an image encoder, an object encoder, and a diffusion model. Image generation apparatus 110 may also include a processor unit, a memory unit, an I/O module, and a user interface. A training component may be implemented on an apparatus other than image generation apparatus 110. The training component is used to train an image generation model. Additionally, image generation apparatus 110 can communicate with database 120 via cloud 115. In some cases, the architecture of the image generation network is also referred to as a network, a machine learning model, or a network model. Further detail regarding the architecture of image generation apparatus 110 is provided with reference to FIGS. 9-13. Further detail regarding the operation of image generation apparatus 110 is provided with reference to FIGS. 2, 8 and 14.

In some cases, image generation apparatus 110 is implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user. The term “cloud” is sometimes used to describe data centers available to many users over the Internet. Some large cloud networks have functions distributed over multiple locations from central servers. A server is designated an edge server if it has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

Database 120 is an organized collection of data. For example, database 120 stores data (e.g., training dataset including training image pairs) in a specified format known as a schema. Database 120 may be structured as a single database, a distributed database, multiple distributed databases, or an emergency backup database. In some cases, a database controller may manage data storage and processing in database 120. In some cases, a user interacts with database controller. In other cases, database controller may operate automatically without user interaction.

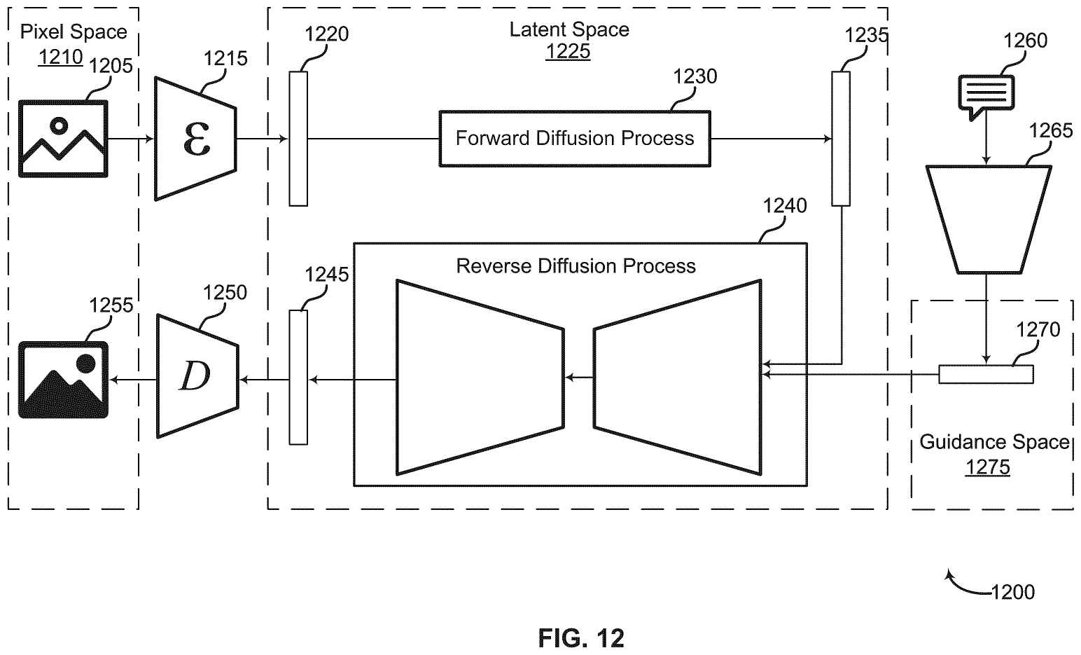

FIG. 2 shows an example of a method 200 for conditional media generation according to aspects of the present disclosure. In some examples, method 200 describes an operation of the image generation model 925 described with reference to FIG. 9 such as an application of the guided latent diffusion model 1200 described with reference to FIG. 12. In some examples, these operations are performed by a system including a processor executing a set of codes to control functional elements of an apparatus.

Additionally or alternatively, steps of the method 200 are performed using special-purpose hardware. Generally, these operations are performed according to the methods and processes described in accordance with aspects of the present disclosure. In some cases, the operations described herein are composed of various substeps, or are performed in conjunction with other operations.

At operation 205, a user provides a text prompt, a reference image, and a transform input. In some cases, the operations of this step refer to, or may be performed by, a user as described with reference to FIG. 1. A user provides a text prompt describing content to be included in a generated media item. For example, a user may provide the prompt “a dog floating in an ocean of milk”. The user may also set an identity score to be 0.5 and a surface area score to be 0.5. In some cases, the identity score and the surface area score can be set by the system internally based on the text prompt and the reference image. For example, “a small dog standing next to a large house” inherently indicates a scale of an object “dog” is relatively small compared to a house and accordingly, a default surface area score (if available) is a small numerical value. In some cases, surface area score and identity score are not both provided (e.g., an identity score is provided by a user while a surface area score is intentionally left blank). In some examples, guidance can be provided in a form other than text, such as via an image, a sketch, or a layout.

At operation 210, the system generates an object embedding representing a target level of transformation. In some cases, the operations of this step refer to, or may be performed by, an image generation apparatus as described with reference to FIGS. 1 and 9.

The system converts the text prompt (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

At operation 215, the system generates a synthetic image. In some cases, the operations of this step refer to, or may be performed by, an image generation apparatus as described with reference to FIGS. 1 and 9.

In some cases, a noise map is initialized that includes random noise. The noise map may be in a pixel space or a latent space. By initializing a media item with random noise, different variations of a media item including the content described by the conditional guidance can be generated. The system generates a media item based on the noise map and the conditional guidance vector. For example, the media item may be generated using a reverse diffusion process as described with reference to FIG. 14.

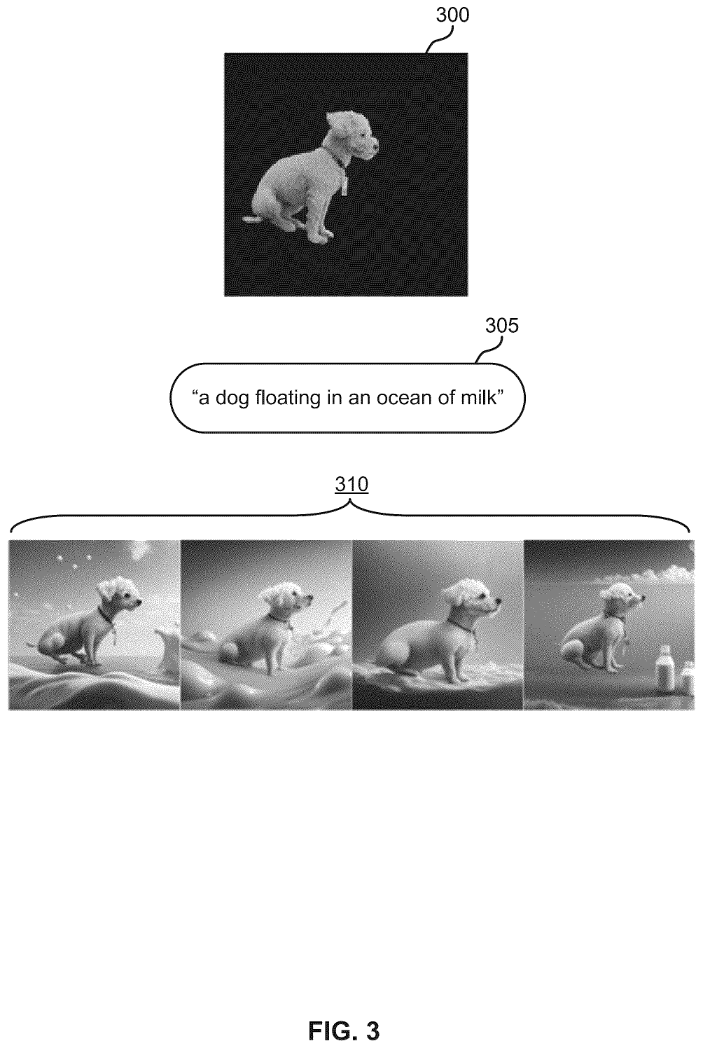

FIG. 3 shows an example of concept based image synthesis according to aspects of the present disclosure. The example shown includes reference image 300, input prompt 305, and synthetic images 310.

In some examples, reference image 300 depicts a dog, which is a target object (concept) to guide the process of image generation. Input prompt 305 is “a dog floating in an ocean of milk” that is converted to text features to guide the generation process. Synthetic images 310 illustrate various images generated based on reference image 300 and input prompt 305. The synthetic images 310 include one or more elements of input prompt 305 and preserve identity of an object in reference image 300. For example, synthetic images 310 depict a dog floating in an ocean of milk. The identity of the object “dog” in synthetic images 310 are similar to that of reference image 300. The synthetic images 310 include variations in background, composition, and style while preserving identity of the target object (concept) in reference image 300.

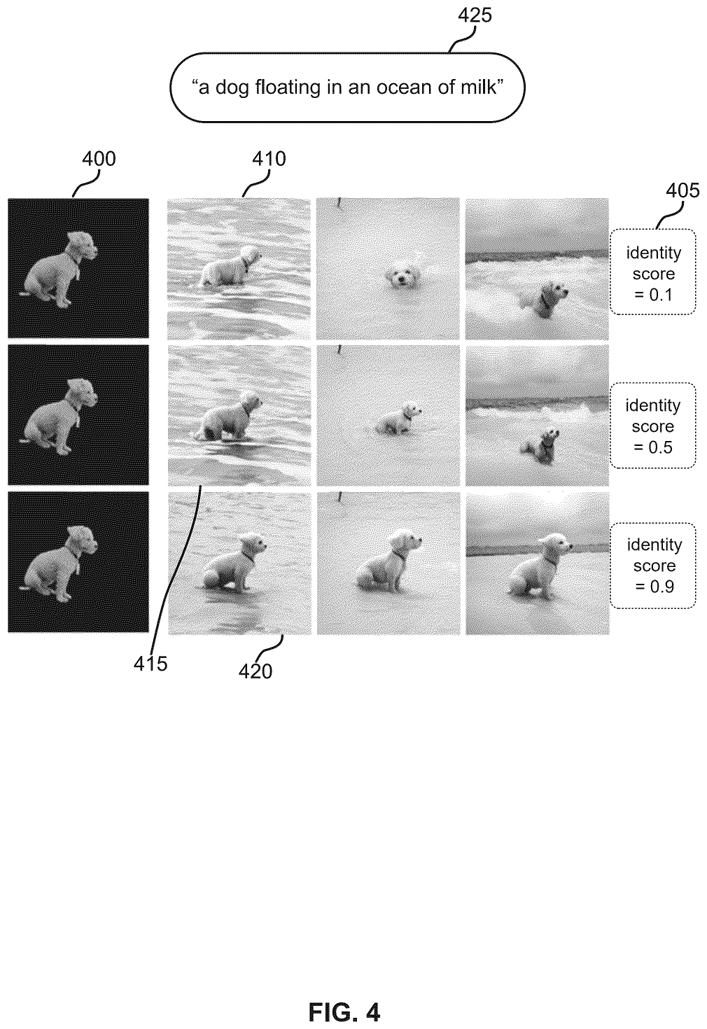

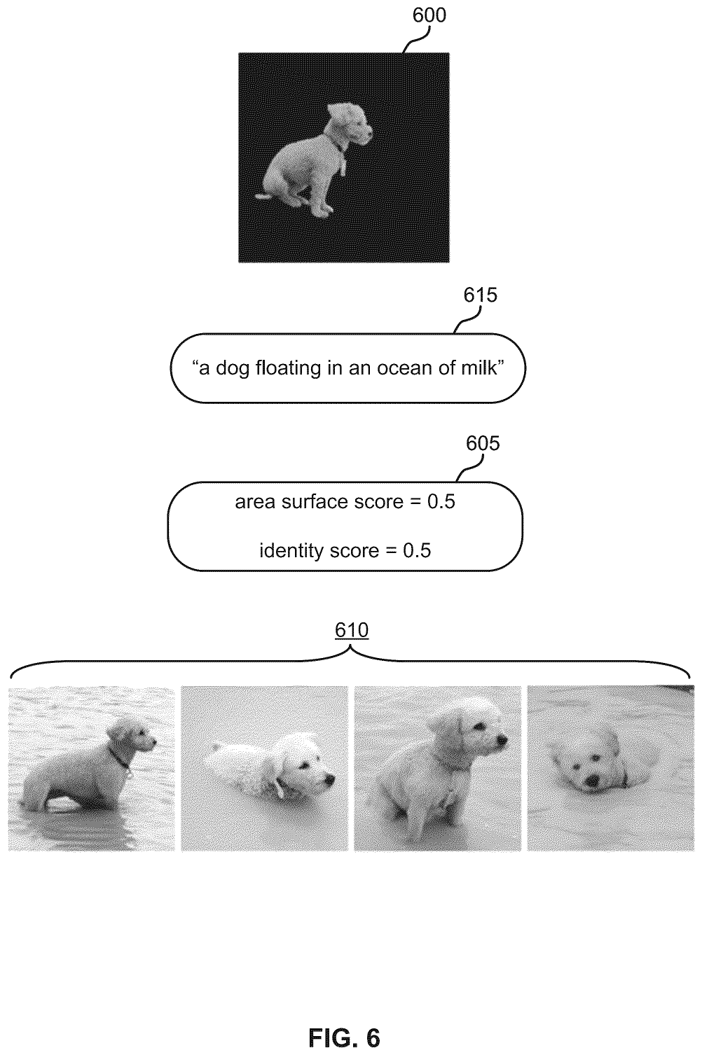

Reference image 300 is an example of, or includes aspects of, the corresponding element described with reference to FIGS. 4-7, and 10. Input prompt 305 is an example of, or includes aspects of, the corresponding element described with reference to FIGS. 4-6. Synthetic images 310 are an example of, or includes aspects of, the corresponding element described with reference to FIG. 6.

FIG. 4 shows an example of identity score effect according to aspects of the present disclosure. The example shown includes reference image 400, transform input 405, first synthetic image 410, second synthetic image 415, third synthetic image 420, and input prompt 425.

Reference image 400 depicts a target object (“dog”). Input prompt 425 is “a dog floating in an ocean of milk” that is converted to text features to guide the generation process. Transform input 405 includes an identity score, which provides a similarity metric between an object of reference image 400 and an object of a generated image. In the first row, first synthetic image 410 is generated based on an identity score of 0.1, showing a relatively low similarity to the object “dog” in reference image 400. In the second row, second synthetic image 415 is generated based on an identity score of 0.5, showing a moderate similarity to the object “dog” in reference image 400. In the third row, third synthetic image 420 is generated based on an identity score of 0.9, showing a higher degree of similarity to the object “dog” in reference image 400. Synthetic images 410, 415, and 420 illustrate the effect of having different identity scores (as input) on the image generation process.

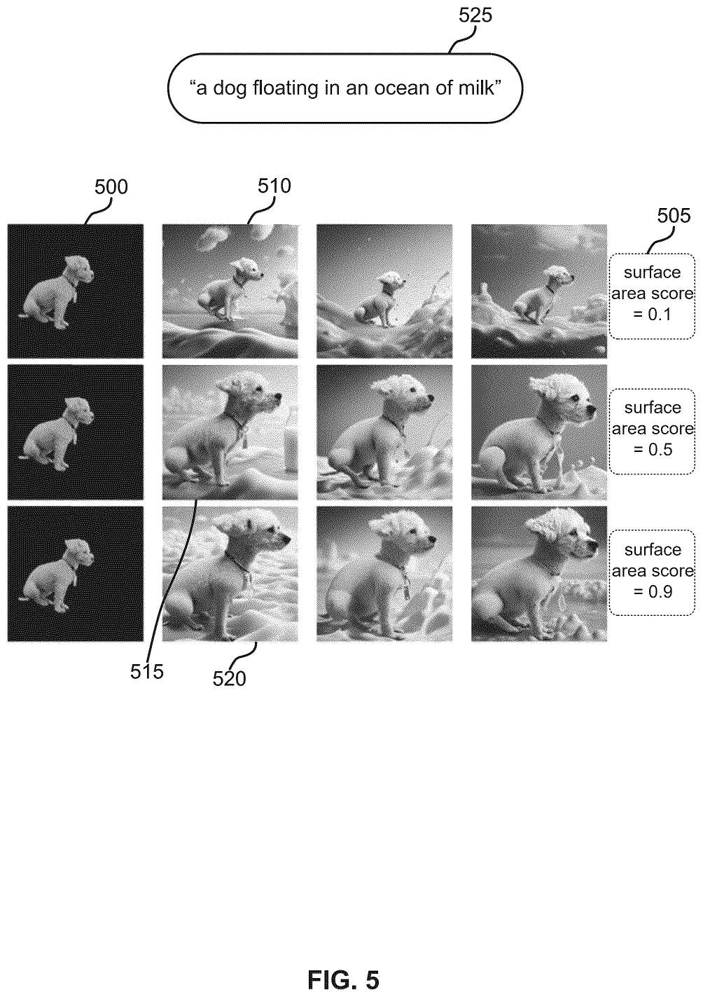

Reference image 400 is an example of, or includes aspects of, the corresponding element described with reference to FIGS. 3, 5-7, and 10. Transform input 405 is an example of, or includes aspects of, the corresponding element described with reference to FIGS. 5-7. Input prompt 425 is an example of, or includes aspects of, the corresponding element described with reference to FIGS. 3, 5, and 6.

FIG. 5 shows an example of surface area score effect according to aspects of the present disclosure. The example shown includes reference image 500, transform input 505, first synthetic image 510, second synthetic image 515, third synthetic image 520, and input prompt 525.

Reference image 500 depicts a target object “dog”. Input prompt 525 is “a dog floating in an ocean of milk” that is converted to text features to guide the generation process. Transform input 505 includes a surface area score, which measures a size of an object in relation to the background of an image. In the first row, first synthetic image 510 is generated based on a surface area score of 0.1, guiding the model to generate the object “dog” that has a smaller size in relation to the background of the image. In the second row, second synthetic image 515 is generated based on a surface area score of 0.5, guiding the model to generate the object “dog” that has a moderate size in relation to the background of the image. In the third row, third synthetic image 520 is generated based on a surface area score of 0.9, guiding the model to generate the object “dog” that has a relatively large size in relation to the background of the image. Synthetic images 510, 515, and 520 illustrate the effect of having different surface area scores on the image generation process.

Reference image 500 is an example of, or includes aspects of, the corresponding element described with reference to FIGS. 3, 4, 6, 7, and 10. Transform input 505 is an example of, or includes aspects of, the corresponding element described with reference to FIGS. 4, 6, and 7. Input prompt 525 is an example of, or includes aspects of, the corresponding element described with reference to FIGS. 3, 4, and 6.

FIG. 6 shows an example of score based effect with both scores according to aspects of the present disclosure. The example shown includes reference image 600, transform input 605, synthetic images 610, and input prompt 615.

Reference image 600 depicts a target object (“dog”). Input prompt 615 is “a dog floating in an ocean of milk” that is converted to text features to guide the generation process. Transform input 605 includes an area surface score and an identity score. Synthetic images 610 are generated based on reference image 600, transform input 605, and input prompt 615. In some examples, the area surface score is set to 0.5 and the identity score is set to 0.5. Synthetic images 610 include an object “dog” having a moderate size in relation to the background of the images. The object “dog” has moderate similarity compared to the target object in reference image 600. Synthetic images 610 demonstrate the combined effect of having an area surface score and an identity score (as input) on the image generation process.

Reference image 600 is an example of, or includes aspects of, the corresponding element described with reference to FIGS. 3-5, 7, and 10. Transform input 605 is an example of, or includes aspects of, the corresponding element described with reference to FIGS. 4, 5, and 7. Synthetic images 610 are an example of, or includes aspects of, the corresponding element described with reference to FIG. 3. Input prompt 615 is an example of, or includes aspects of, the corresponding element described with reference to FIGS. 3-5.

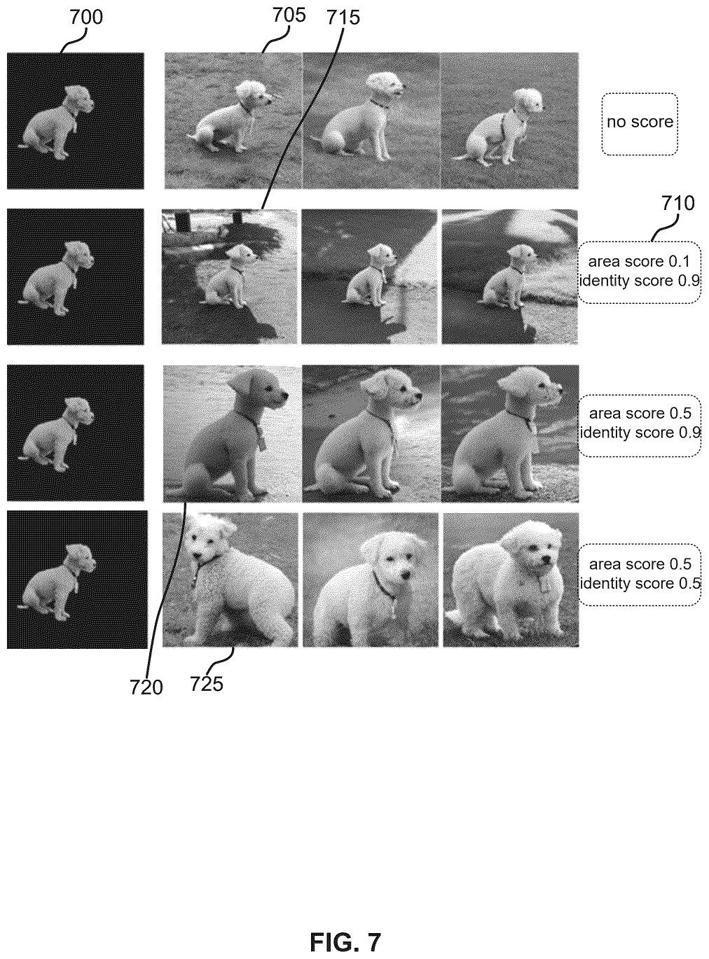

FIG. 7 shows an example of score based effect with both scores according to aspects of the present disclosure. The example shown includes reference image 700, first synthetic image 705, transform input 710, second synthetic image 715, third synthetic image 720, and fourth synthetic image 725.

Reference image 700 depicts a target object (“dog”). First synthetic image 705 is generated without having any score as input. Transform input 710 includes a surface area score and an identity score. Second synthetic image 715 is generated based on transform input 710 (i.e., a surface area score of 0.1 and an identity score of 0.9). The object “dog” in second synthetic image 715 has a small size in relation to the background of the image while showing a high similarity to the target object in reference image 700.

Third synthetic image 720 is generated based on a surface area score of 0.5 and an identity score of 0.9. The object “dog” in third synthetic image 720 has a moderate size in relation to the background of the image while showing a high similarity to the target object in reference image 700.

Fourth synthetic image 725 is generated based on an area score of 0.5 and an identity score of 0.5. The object “dog” in fourth synthetic image 725 has a moderate size in relation to the background of the image while showing a moderate similarity to the target object in reference image 700. Synthetic images 705, 715, 720, and 725 illustrate the combined effect of having a surface area score and an identity score on the image generation process.

Reference image 700 is an example of, or includes aspects of, the corresponding element described with reference to FIGS. 3-6, and 10. Transform input 710 is an example of, or includes aspects of, the corresponding element described with reference to FIGS. 4-6.

FIG. 8 shows an example of a method 800 for image generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

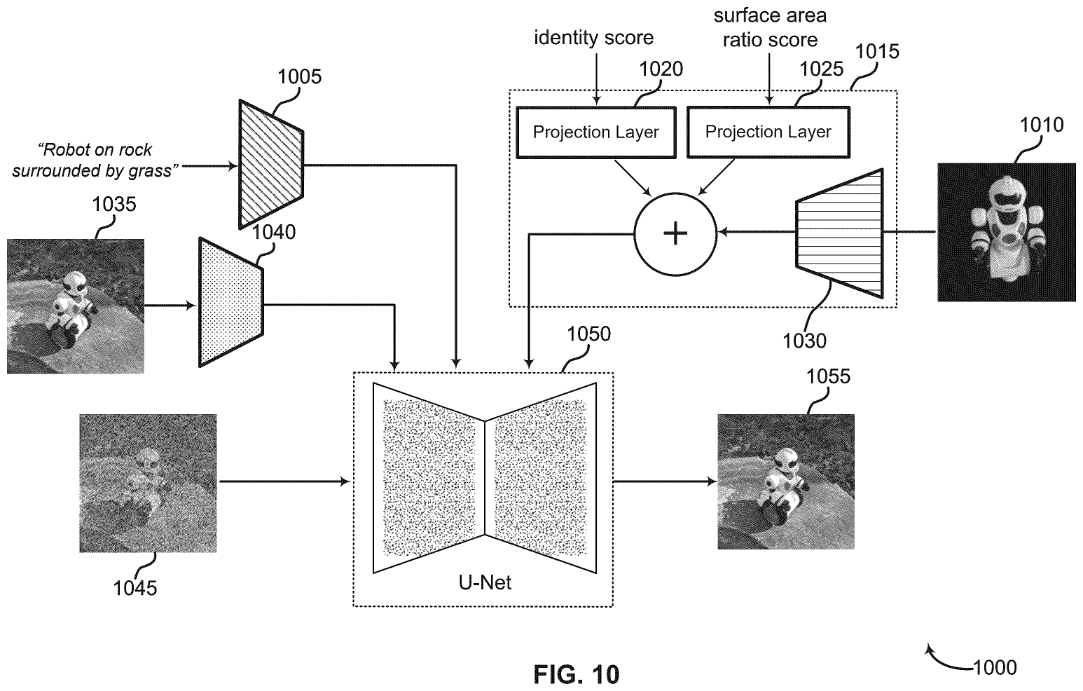

At operation 805, the system obtains an input prompt, a reference image, and a transform input, where the input prompt describes a scene, the reference image depicts an object, and the transform input indicates a target level of a transformation for the object. In some cases, the operations of this step refer to, or may be performed by, an image generation model as described with reference to FIGS. 9 and 10.

In some examples, the transform input includes a size parameter, an identity parameter, or both. The transform input indicates a target level of identity preservation for the object. In some examples, the identity parameter indicates a pose of the object, a view angle of the object, or both. The size parameter indicates a target scale of the object relative to the reference image. In some cases, a target level of a transformation for the object is represented by the identity parameter, the size parameter, or both. Embodiments of the present disclosure are not limited to above-mentioned parameters. Other score based parameters may also be used (e.g., a pose parameters, a view parameter, a geometry parameter, a scale parameter).

In some cases, an identity score guides an image generation model to generate images with certain flexibility regarding the identity of the object provided in the reference image. The flexibility can be in relation to the overall identity of the object as well as the pose and view angle of the object.

In some cases, a surface area score guides an image generation model to generate objects having an adjustable size in relation to the background of the images (e.g., a number of pixels occupied by the object in the synthetic image). A surface area score towards 1 indicates that the object occupies most of the image. A surface area score towards 0 indicates that the object is small in relation to the background of the image.

At operation 810, the system generates, using an object encoder of an image generation model, an object embedding based on the reference image and the transform input, where the object embedding represents the object and the target level of the transformation. In some cases, the operations of this step refer to, or may be performed by, an object encoder as described with reference to FIGS. 9-11.

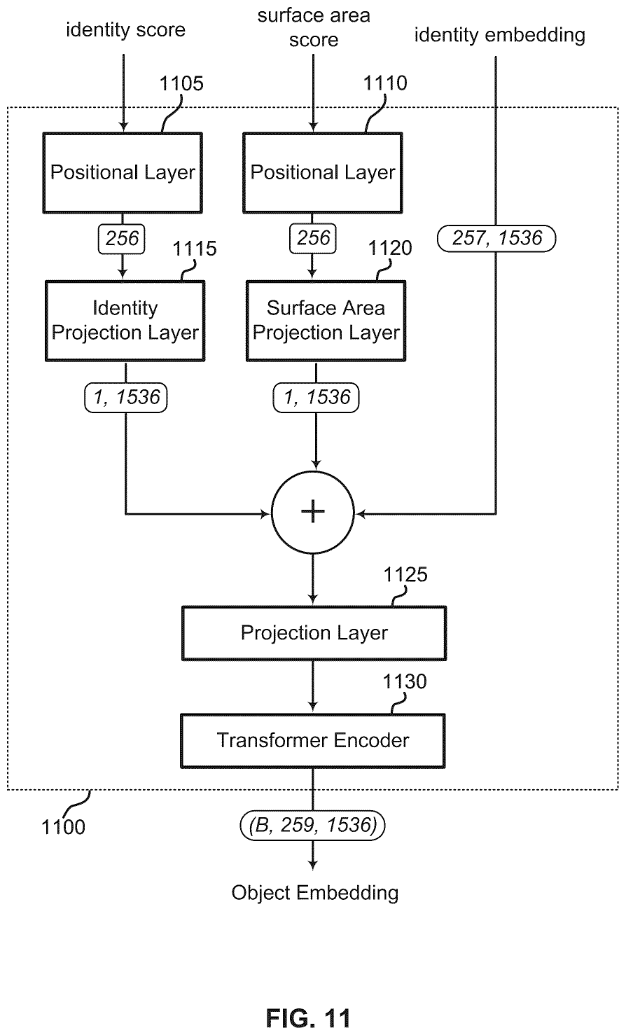

In some embodiments, an object encoder includes an identity positional layer, an area positional layer, an identity projection layer, an area projection layer, a projection layer, and a transformer encoder. In some cases, the object encoder includes an identity encoder that generates an identity embedding based on the reference image. The identity projection layer generates an identity projected embedding. The area projection layer generates an area projected embedding. The identity projected embedding, the area projected embedding, and the identity embedding are concatenated to obtain a concatenated embedding. The object encoder generates an object embedding based on the concatenated embedding. Details regarding the operation of the object encoder are described with reference to FIGS. 10 and 11.

At operation 815, the system generates, using the image generation model, a synthetic image based on the input prompt and the object embedding, where the synthetic image depicts the object in the scene from the input prompt with the target level of the transformation. In some cases, the operations of this step refer to, or may be performed by, an image generation model as described with reference to FIGS. 9 and 10.

In FIGS. 1-8, a method, apparatus, and non-transitory computer readable medium for image generation are described. One or more embodiments of the method, apparatus, and non-transitory computer readable medium include obtaining an input prompt, a reference image, and a transform input, wherein the input prompt describes a scene, the reference image depicts an object, and the transform input indicates a target level of a transformation for the object; generating, using an object encoder of an image generation model, an object embedding based on the reference image and the transform input, wherein the object embedding represents the object and the target level of the transformation; and generating, using the image generation model, a synthetic image based on the input prompt and the object embedding, wherein the synthetic image depicts the object in the scene from the input prompt with the target level of the transformation.

Some examples of the method, apparatus, and non-transitory computer readable medium further include obtaining a preliminary image depicting the object. Some examples further include removing a background from the preliminary image to obtain the reference image.

Some examples of the method, apparatus, and non-transitory computer readable medium further include generating a preliminary embedding representing the object. Some examples further include transforming the preliminary embedding based on the transform input to obtain the object embedding.

Some examples of the method, apparatus, and non-transitory computer readable medium further include encoding the transform input to obtain a projection vector, wherein the preliminary embedding is transformed based on the projection vector.

Some examples of the method, apparatus, and non-transitory computer readable medium further include obtaining a noise map. Some examples further include denoising the noise map based on the object embedding.

Some examples of the method, apparatus, and non-transitory computer readable medium further include encoding the input prompt to obtain a text embedding, wherein the synthetic image is generated based on the text embedding.

Some examples of the method, apparatus, and non-transitory computer readable medium further include obtaining an additional reference image depicting the scene. The additional reference image is an image fed to a multi-modal encoder such as CLIP model. “CLIP” refers to Contrastive Language-Image Pre-training, which is a method of image representation learning from natural language supervision. A CLIP model is a joint image and text embedding model trained using image and text pairs in a self-supervised way. Some examples further include encoding the additional reference image to obtain a reference embedding, wherein the synthetic image is generated based on the reference embedding.

In some examples, the transform input includes a size parameter, an identity parameter, or both. In some examples, the identity parameter indicates a pose of the object, a view angle of the object, or both. In some examples, the size parameter indicates a target scale of the object relative to the reference image. In some examples, the transform input indicates a target level of identity preservation for the object.

### Network Architecture

FIG. 9 shows an example of an image generation apparatus 900 according to aspects of the present disclosure. The example shown includes image generation apparatus 900, processor unit 905, I/O module 910, user interface 915, memory unit 920, image generation model 925, and training component 950. Image generation apparatus 900 is an example of, or includes aspects of, the corresponding element described with reference to FIG. 1.

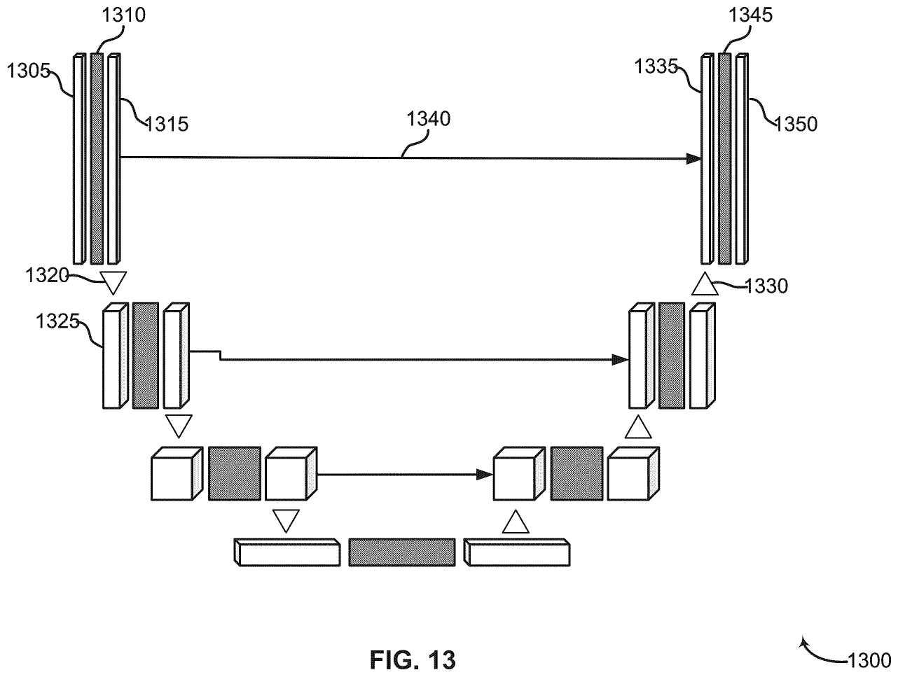

Image generation apparatus 900 may include an example of, or aspects of, the guided diffusion model described with reference to FIG. 12 and the U-Net described with reference to FIG. 13. In some embodiments, image generation apparatus 900 includes processor unit 905, memory unit 920, image generation model 925, I/O module 910, and training component 950. Training component 950 updates parameters of the image generation model 925 stored in memory unit 920. In some examples, the training component 950 is located outside the image generation apparatus 900.

Processor unit 905 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

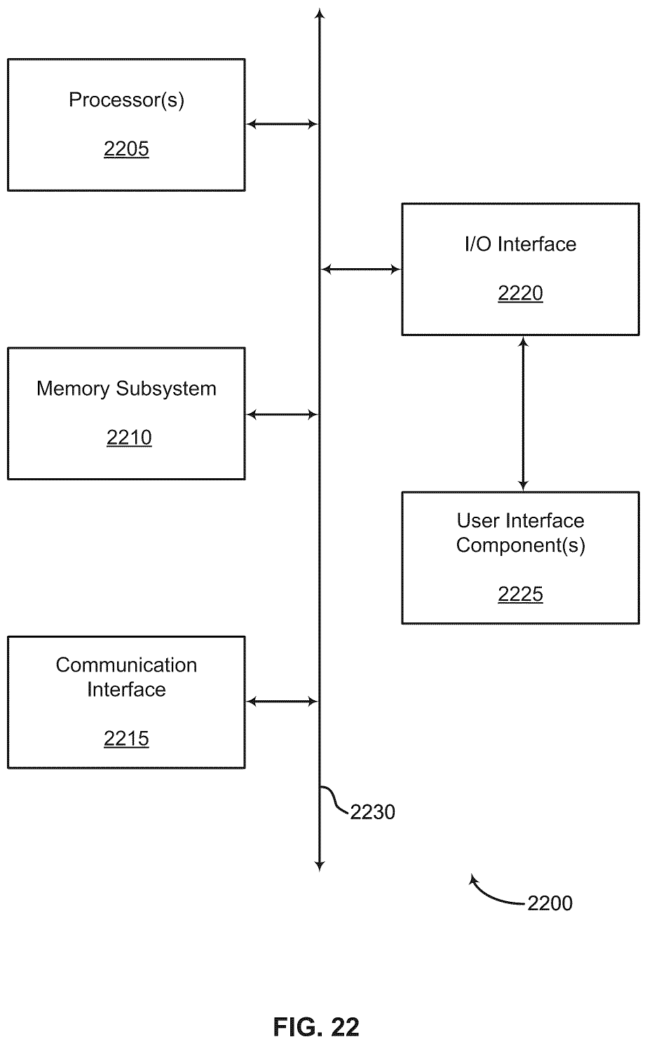

In some cases, processor unit 905 is configured to operate a memory array using a memory controller. In other cases, a memory controller is integrated into processor unit 905. In some cases, processor unit 905 is configured to execute computer-readable instructions stored in memory unit 920 to perform various functions. In some aspects, processor unit 905 includes special purpose components for modem processing, baseband processing, digital signal processing, or transmission processing. According to some aspects, processor unit 905 comprises one or more processors described with reference to FIG. 22.

Memory unit 920 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 905 to perform various functions described herein.

In some cases, memory unit 920 includes a basic input/output system (BIOS) that controls basic hardware or software operations, such as an interaction with peripheral components or devices. In some cases, memory unit 920 includes a memory controller that operates memory cells of memory unit 920. For example, the memory controller may include a row decoder, column decoder, or both. In some cases, memory cells within memory unit 920 store information in the form of a logical state. According to some aspects, memory unit 920 is an example of the memory subsystem 2210 described with reference to FIG. 22.

According to some aspects, image generation apparatus 900 uses one or more processors of processor unit 905 to execute instructions stored in memory unit 920 to perform functions described herein. For example, the image generation apparatus 900 may obtain an input prompt, a reference image, and a transform input, where the input prompt describes a scene, the reference image depicts an object, and the transform input indicates a target level of a transformation for the object. The image generation apparatus 900 generates, using an object encoder of an image generation model, an object embedding based on the reference image and the transform input, where the object embedding represents the object and the target level of the transformation.

The memory unit 920 may include an image generation model 925 trained to receive an input prompt, a reference image, and a transform input, wherein the input prompt describes a scene, the reference image depicts an object, and the transform input indicates a target level of a transformation for the object, to generate an object embedding based on the reference image and the transform input, wherein the object embedding represents the object and the target level of the transformation, and to generate a synthetic image based on the input prompt and the object embedding, wherein the synthetic image depicts the object in the scene from the input prompt with the target level of the transformation. For example, after training, the image generation model 925 may perform inferencing operations as described with reference to FIGS. 2 and 14 to generate a synthetic image based on the input prompt and the object embedding, where the synthetic image depicts the object in the scene from the input prompt with the target level of the transformation.

In some embodiments, the image generation model 925 is an artificial neural network (ANN) such as the guided diffusion model described with reference to FIG. 12 and the U-Net described with reference to FIG. 13. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of image generation model 925 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

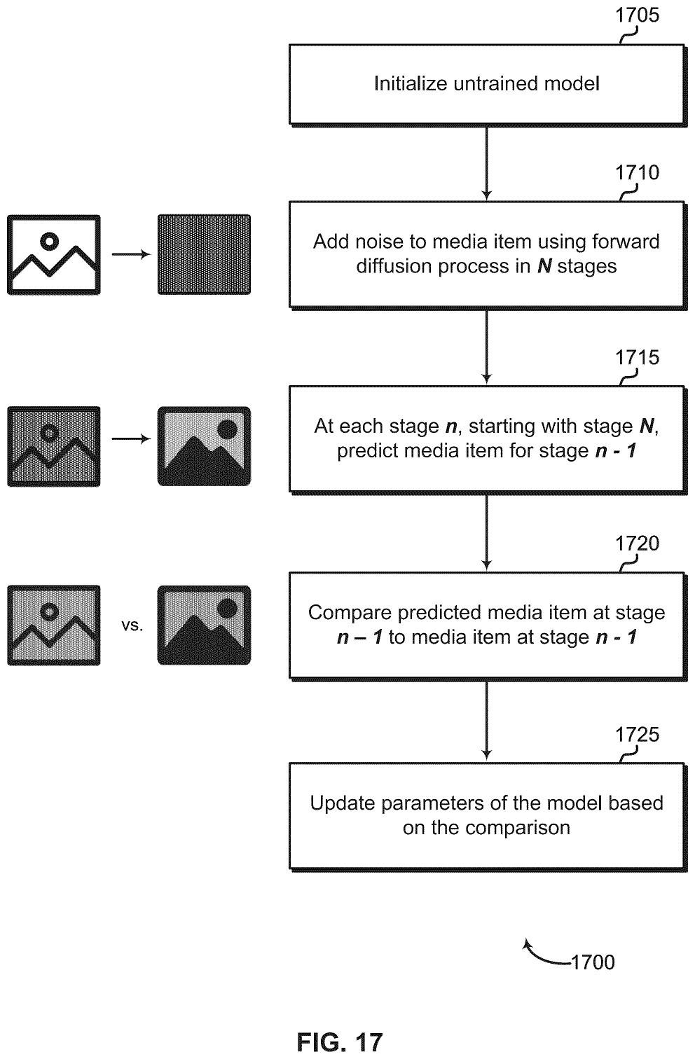

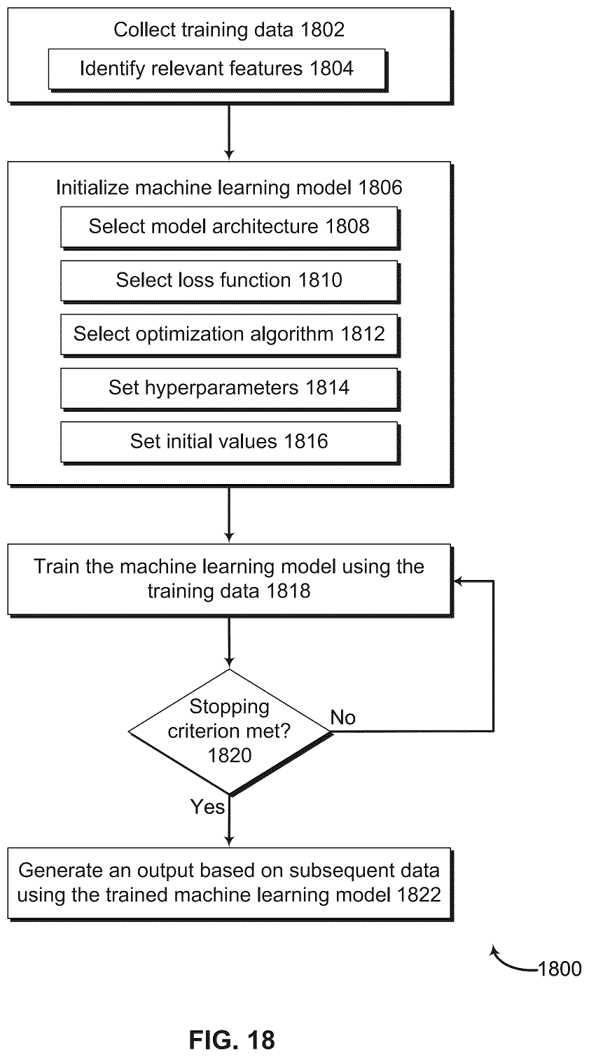

Training component 950 may train the image generation model 925. For example, parameters of the image generation model 925 can be learned or estimated from training data and then used to make predictions or perform tasks based on learned patterns and relationships in the data. In some examples, the parameters are adjusted during the training process to minimize a loss function or maximize a performance metric (e.g., as described with reference to FIGS. 17 and 18). The goal of the training process may be to find optimal values for the parameters that allow the machine learning model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the image generation model 925 can be used to make predictions on new, unseen data (i.e., during inference).

I/O module 910 receives inputs from and transmits outputs of the image generation apparatus 900 to other devices or users. For example, I/O module 910 receives inputs for the image generation model 925 and transmits outputs of the image generation model 925. According to some aspects, I/O module 910 is an example of the I/O interface 2220 described with reference to FIG. 22.

According to some embodiments, image generation model 925 obtains an input prompt, a reference image, and a transform input, where the input prompt describes a scene, the reference image depicts an object, and the transform input indicates a target level of a transformation for the object. In some examples, image generation model 925 generates a synthetic image based on the input prompt and the object embedding, where the synthetic image depicts the object in the scene from the input prompt with the target level of the transformation.

In some examples, image generation model 925 obtains a preliminary image depicting the object. Image generation model 925 removes a background from the preliminary image to obtain the reference image. In some examples, image generation model 925 generates a preliminary embedding representing the object. Image generation model 925 transforms the preliminary embedding based on the transform input to obtain the object embedding. In some examples, image generation model 925 encodes the transform input to obtain a projection vector, where the preliminary embedding is transformed based on the projection vector.

In some examples, the transform input includes a size parameter, an identity parameter, or both. In some examples, the identity parameter indicates a pose of the object, a view angle of the object, or both. In some examples, the size parameter indicates a target scale of the object relative to the reference image. In some examples, the transform input indicates a target level of identity preservation for the object.

According to some embodiments, image generation model 925 is trained to receive an input prompt, a reference image, and a transform input, where the input prompt describes a scene, the reference image depicts an object, and the transform input indicates a target level of a transformation for the object, to generate an object embedding based on the reference image and the transform input, where the object embedding represents the object and the target level of the transformation, and to generate a synthetic image based on the input prompt and the object embedding, wherein the synthetic image depicts the object in the scene from the input prompt with the target level of the transformation.

In some examples, the image generation model 925 includes an object encoder 940 trained to generate the object embedding. In some examples, the image generation model 925 includes a diffusion model 945 trained to generate the synthetic image. Image generation model 925 is an example of, or includes aspects of, the corresponding element described with reference to FIG. 10.

In one embodiment, image generation model 925 includes text encoder 930, image encoder 935, object encoder 940, and diffusion model 945. Text encoder 930 encodes the input prompt to obtain a text embedding, where the synthetic image is generated based on the text embedding. Text encoder 930 is an example of, or includes aspects of, the corresponding element described with reference to FIG. 10.

According to some embodiments, image encoder 935 obtains an additional reference image depicting the scene. In some examples, image encoder 935 encodes the additional reference image to obtain a reference embedding, where the synthetic image is generated based on the reference embedding. Image encoder 935 is an example of, or includes aspects of, the corresponding element described with reference to FIG. 10.

According to some embodiments, object encoder 940 generates an object embedding based on the reference image and the transform input, where the object embedding represents the object and the target level of the transformation. Object encoder 940 is an example of, or includes aspects of, the corresponding element described with reference to FIGS. 10 and 11.

According to some embodiments, diffusion model 945 obtains a noise map. Diffusion model 945 denoises the noise map based on the object embedding. Diffusion model 945 is an example of, or includes aspects of, the corresponding element described with reference to FIG. 10.

According to some embodiments, training component 950 obtains a training set including a training input image, a training target image, and a training transform input, where the training target image depicts an object from the training input image with a target level of a transformation indicated by the training transform input. In some examples, training component 950 trains, using the training set, an image generation model 925 to generate an object embedding that represents the object with the target level of the transformation and to generate a synthetic image based on the object embedding, where the synthetic image depicts the object with the target level of the transformation.

In some examples, training component 950 jointly trains object encoder 940 that generates the object embedding and diffusion model 945 that generates the synthetic image. In some examples, training component 950 obtains a preliminary image. Training component 950 removes a background from the preliminary image to obtain the training input image. In some examples, training component 950 obtains a preliminary image. Training component 950 applies an image transformation to the preliminary image to obtain the training input image. In some examples, training component 950 generates an intermediate output image. Training component 950 computes a reconstruction loss between the intermediate output image and the training target image. Training component 950 updates parameters of the image generation model 925 based on the reconstruction loss.

FIG. 10 shows an example of an image generation model 1000 according to aspects of the present disclosure. The example shown includes image generation model 1000, text encoder 1005, reference image 1010, object encoder 1015, additional reference image 1035, image encoder 1040, noise map 1045, diffusion model 1050, and synthetic image 1055. Image generation model 1000 is an example of, or includes aspects of, the corresponding element described with reference to FIG. 9.

In one embodiment, object encoder 1015 includes identity projection layer 1020, area projection layer 1025, and identity encoder 1030. Object encoder 1015 is an example of, or includes aspects of, the corresponding element described with reference to FIGS. 9 and 11. Identity projection layer 1020 is an example of, or includes aspects of, the corresponding element described with reference to FIG. 11. Area projection layer 1025 is an example of, or includes aspects of, the corresponding element described with reference to FIG. 11.

In some examples, identity encoder 1030 includes a self-supervised model (e.g., DINO encoder) that generates structural representation based on reference image 1010. Identity encoder 1030 generates embeddings that provides a sense on the fine-grained structure of an object in the reference image 1010 along with color and texture information. For example, image generation model 1000 focuses on the “hero” object in reference image 1010. Image generation model 1000 masks out the background and passes the foreground of the object to identity encoder 1030. The identity encoder 1030 generates an embedding of the shape (e.g., 257×1536). One of the embedding in the 257 dimensions provides a global structure information of the reference image 1010. The identity encoder 1030 captures the identity of the object (i.e., “hero”). Reference image 1010 is an example of, or includes aspects of, the corresponding element described with reference to FIGS. 3-7.

Text encoder 1005 (e.g., T5 encoder) extracts a text embedding based on a text prompt. For example, the text prompt is “robot on rock surrounded by grass”. In some examples, text encoder 1005 includes a CLIP encoder or other encoder which can convert a text prompt into a vector representation. During training, the text prompt describes a ground-truth image. Text encoder 1005 is an example of, or includes aspects of, the corresponding element described with reference to FIG. 9.

Image encoder 1040 encodes and outputs image semantic information in the form of a 1024 vector. In some examples, image encoder 1040 includes a CLIP encoder or other encoders that can extract image embeddings from images. Image encoder 1040 is an example of, or includes aspects of, the corresponding element described with reference to FIG. 9.

Diffusion model 1050 includes a base diffusion U-Net that is conditioned to model the distribution P(I|X, Y), where/denotes the 128×128 RGB image, X∈ [symbol] ¹⁰²⁴ is the ground-truth image embedding (e.g., CLIP embedding) and Y∈ [symbol] ^{128×1024} is the text embedding (e.g., representation from T5 encoder). In some embodiments, diffusion model 1050 is trained under this setting for millions of iterations. Once the diffusion model 1050 has learnt efficiently to generate images based on a text prompt or an image prompt as conditions to the model, diffusion model 1050 is used as a base model for subsequent fine-tuning. Diffusion model 1050 is an example of, or includes aspects of, the corresponding element described with reference to FIG. 9. Embodiments of the present disclosure are not limited to using U-Net and image generation model 1000 may replace U-Net with other generative models for image generation.

FIG. 11 shows an example of an object encoder 1100 of an image generation model according to aspects of the present disclosure. Object encoder 1100 is an example of, or includes aspects of, the corresponding element described with reference to FIGS. 9 and 10. In one embodiment, object encoder 1100 includes identity positional layer 1105, area positional layer 1110, identity projection layer 1115, area projection layer 1120, projection layer 1125, and transformer encoder 1130.

In some embodiments, an identity score and a surface area score (e.g., scalar values of view and area) are positionally encoded and projected to a same dimension as an identity embedding (e.g., an embedding from DINO). In some examples, an identity score is fed to identity positional layer 1105 to output an identity positional encoding, which has a dimension of 256. A surface area score is fed to area positional layer 1110 to output an area positional encoding, which has a dimension of 256. The identity positional encoding is fed to identity projection layer 1115 to output an identity projected embedding that has a dimension of 1×1536. The area positional encoding is fed to area projection layer 1120 to output an area projected embedding that has a dimension of 1×1536.

Identity projection layer 1115 is an example of, or includes aspects of, the corresponding element described with reference to FIG. 10. Area projection layer 1120 is an example of, or includes aspects of, the corresponding element described with reference to FIG. 10.

The identity (e.g., view) and surface area are treated as separate tokens and appended to the identity embedding tokens. In some examples, the identity embedding has a dimension of 257×1536.

The identity projected embedding, the area projected embedding, and the identity embedding are concatenated to obtain a concatenated embedding that has a dimension of 259×1536. The 259 tokens are projected via projection layer 1125 and then encoded using a transformer encoder 1130 to output an object embedding. The object embedding has a dimension of 259×1536. In the example shown in FIG. 11, B denotes a batch. The self-attention blocks inside transformer encoder 1130 ensure the information flow across the identity tokens and surface area tokens and necessary tokens are weighted and attended to.

In some cases, the object encoder 1100 performs steps comprising generating a preliminary identity embedding based on a reference image; projecting the identity score to obtain a projection vector; and concatenating the preliminary identity embedding and the projection vector to obtain a concatenated embedding, where the object embedding is based on the concatenated embedding.

The image generation model (with reference to FIG. 9) learns to generate images without completely relying on the scores (e.g., identity scores, surface area scores). During training, each of the scores is dropped 10% of the time randomly. The training process includes converting projections to 0 vectors. At inference time, when no scores are provided, the image generation model converts the projections to 0 vectors indicating that the model estimates its own score based on the knowledge it has gained during training.

FIG. 12 shows an example of a guided latent diffusion model 1200 according to aspects of the present disclosure. The guided latent diffusion model 1200 depicted in FIG. 12 is an example of, or includes aspects of, the corresponding element (i.e., diffusion model 945) described with reference to FIG. 9.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (i.e., latent diffusion).

Diffusion models work by iteratively adding noise to the data during a forward process and then learning to recover the data by denoising the data during a reverse process. For example, during training, guided latent diffusion model 1200 may take an original image 1205 in a pixel space 1210 as input and apply and image encoder 1215 to convert original image 1205 into original image features 1220 in a latent space 1225. Then, a forward diffusion process 1230 gradually adds noise to the original image features 1220 to obtain noisy features 1235 (also in latent space 1225) at various noise levels.

Next, a reverse diffusion process 1240 (e.g., a U-Net ANN) gradually removes the noise from the noisy features 1235 at the various noise levels to obtain denoised image features 1245 in latent space 1225. In some examples, the denoised image features 1245 are compared to the original image features 1220 at each of the various noise levels, and parameters of the reverse diffusion process 1240 of the diffusion model are updated based on the comparison. Finally, an image decoder 1250 decodes the denoised image features 1245 to obtain an output image 1255 in pixel space 1210. In some cases, an output image 1255 is created at each of the various noise levels. The output image 1255 can be compared to the original image 1205 to train the reverse diffusion process 1240.

In some cases, image encoder 1215 and image decoder 1250 are pre-trained prior to training the reverse diffusion process 1240. In some examples, they are trained jointly, or the image encoder 1215 and image decoder 1250 and fine-tuned jointly with the reverse diffusion process 1240.

The reverse diffusion process 1240 can also be guided based on a text prompt 1260, or another guidance prompt, such as an image, a layout, a segmentation map, etc. The text prompt 1260 can be encoded using a text encoder 1265 (e.g., a multimodal encoder) to obtain guidance features 1270 in guidance space 1275. The guidance features 1270 can be combined with the noisy features 1235 at one or more layers of the reverse diffusion process 1240 to ensure that the output image 1255 includes content described by the text prompt 1260. For example, guidance features 1270 can be combined with the noisy features 1235 using a cross-attention block within the reverse diffusion process 1240.

FIG. 13 shows an example of U-Net 1300 according to aspects of the present disclosure. In some examples, U-Net 1300 is an example of the component that performs the reverse diffusion process 1240 of guided latent diffusion model 1200 described with reference to FIG. 12 and includes architectural elements of the diffusion model 945 described with reference to FIG. 9. The U-Net 1300 depicted in FIG. 13 is an example of, or includes aspects of, the architecture used within the reverse diffusion process described with reference to FIG. 12.

In some examples, diffusion models are based on a neural network architecture known as a U-Net. The U-Net 1300 takes input features 1305 having an initial resolution and an initial number of channels and processes the input features 1305 using an initial neural network layer 1310 (e.g., a convolutional network layer) to produce intermediate features 1315. The intermediate features 1315 are then down-sampled using a down-sampling layer 1320 such that down-sampled features 1325 have a resolution less than the initial resolution and a number of channels greater than the initial number of channels.

This process is repeated multiple times, and then the process is reversed. That is, the down-sampled features 1325 are up-sampled using up-sampling process 1330 to obtain up-sampled features 1335. The up-sampled features 1335 can be combined with intermediate features 1315 having the same resolution and number of channels via a skip connection 1340. These inputs are processed using a final neural network layer 1345 to produce output features 1350. In some cases, the output features 1350 have the same resolution as the initial resolution and the same number of channels as the initial number of channels.

In some cases, U-Net 1300 takes additional input features to produce conditionally generated output. For example, the additional input features could include a vector representation of an input prompt. The additional input features can be combined with the intermediate features 1315 within the neural network at one or more layers. For example, a cross-attention module can be used to combine the additional input features and the intermediate features 1315.

FIG. 14 shows an example of diffusion process 1400 according to aspects of the present disclosure. In some examples, diffusion process 1400 describes an operation of the diffusion model 945 described with reference to FIG. 9, such as the reverse diffusion process 1240 of guided latent diffusion model 1200 described with reference to FIG. 12.

As described above with reference to FIG. 12, using a diffusion model can involve both a forward diffusion process 1405 for adding noise to a media item (or features in a latent space) and a reverse diffusion process 1410 for denoising the media item (or features) to obtain a denoised media item. The forward diffusion process 1405 can be represented as q(xₜ|xₜ₋₁), and the reverse diffusion process 1410 can be represented as p(xₜ₋₁|xₜ). In some cases, the forward diffusion process 1405 is used during training to generate media items with successively greater noise, and a neural network is trained to perform the reverse diffusion process 1410 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 1410, the model begins with noisy data x_{T}, such as a noisy media item 1415 and denoises the data to obtain the p(xₜ₋₁|xₜ). At each step t−1, the reverse diffusion process 1410 takes xₜ, such as first intermediate media item 1420, and t as input. Here, t represents a step in the sequence of transitions associated with different noise levels, The reverse diffusion process 1410 outputs xₜ₋₁, such as second intermediate media item 1425 iteratively until x_{T} reverts back to x₀, the original media item 1430. The reverse process can be represented as:

$${p}_{θ} ( {x}_{t - 1} \vert {x}_{t} ) : = N ( {x}_{t - 1} ; {μ}_{θ} ( {x}_{t} , t ) , {\sum }_{θ} ( {x}_{t} , t ) ) . \qquad ( 1 )$$

The joint probability of a sequence of samples in the Markov chain can be written as a product of conditionals and the marginal probability:

$${x}_{T} : {p}_{θ} ( {x}_{0 : T} ) : = p ( {x}_{T} ) {\prod }_{t = 1}^{T} {p}_{θ} ( {x}_{t - 1} \vert {x}_{t} ) , \qquad ( 2 )$$

where p(x_{T})=N(x_{T}; 0,1) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At inference time, observed data x₀ in a pixel space can be mapped into a latent space as input and a generated data \tilde{x} is mapped back into the pixel space from the latent space as output. In some examples, x₀ represents an original input media item with low quality, latent variables x₁, . . . , x_{T} represent noisy media items, and x represents the generated item with high quality.

In FIGS. 9-14, an apparatus and method for image generation are described. One or more embodiments of the apparatus and method include at least one processor; at least one memory including instructions executable by the at least one processor; and an image generation model comprising parameters stored in the at least one memory and trained to receive an input prompt, a reference image, and a transform input, wherein the input prompt describes a scene, the reference image depicts an object, and the transform input indicates a target level of a transformation for the object, to generate an object embedding based on the reference image and the transform input, wherein the object embedding represents the object and the target level of the transformation, and to generate a synthetic image based on the input prompt and the object embedding, wherein the synthetic image depicts the object in the scene from the input prompt with the target level of the transformation.

In some examples, the image generation model comprises an object encoder trained to generate the object embedding. In some examples, the image generation model comprises a diffusion model trained to generate the synthetic image.

Some examples of the apparatus and method further include a text encoder configured to encode the input prompt to obtain a text embedding, wherein the synthetic image is generated based on the text embedding.

Some examples of the apparatus and method further include an image encoder configured to encode an additional reference image to obtain a reference embedding, wherein the synthetic image is generated based on the reference embedding.

### Training and Evaluation

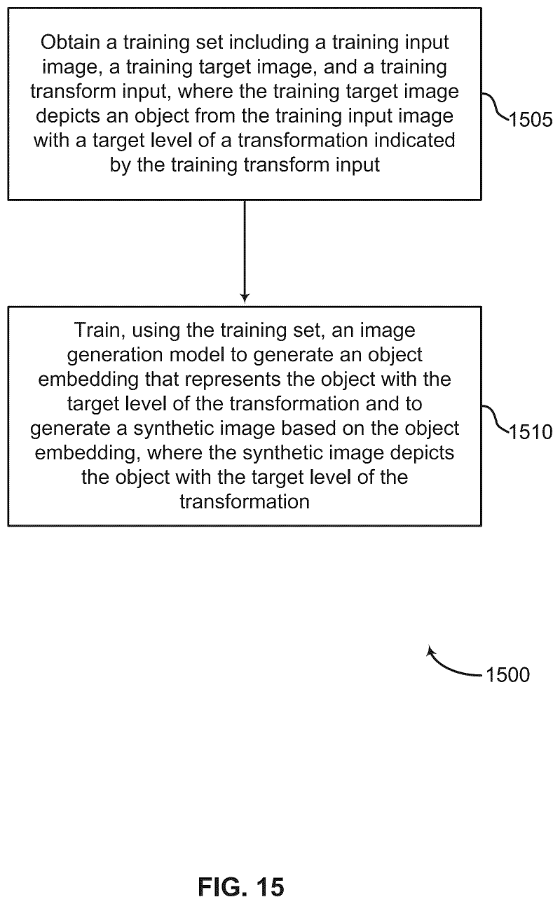

FIG. 15 shows an example of a method 1500 for training a machine learning model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1505, the system obtains a training set including a training input image, a training target image, and a training transform input, where the training target image depicts an object from the training input image with a target level of a transformation indicated by the training transform input. In some cases, the operations of this step refer to, or may be performed by, a training component as described with reference to FIG. 9. In some cases, obtaining a training set can include creating training data for training an image generation model.

In some examples, creating a training set includes collecting paired images of a same object from MVimgNet dataset. The training set includes 1.4 M image pairs across 238 object categories. When sampling the training pairs in the dataloader for model training, the training process includes a window size parameter used to indicate how different the viewpoints are between the paired objects. This way, the training component can control how much viewpoint change the image generation model can learn from the training set.

At operation 1510, the system trains, using the training set, an image generation model to generate an object embedding that represents the object with the target level of the transformation and to generate a synthetic image based on the object embedding, where the synthetic image depicts the object with the target level of the transformation. In some cases, the operations of this step refer to, or may be performed by, a training component as described with reference to FIG. 9.

In some examples, an image generation model is initialized using random values. In other examples, the image generation model is initialized based on a pre-trained model. In some examples, the image generation model includes base parameters from a pre-trained model. In some cases, training the image generation model jointly training an object encoder that generates the object embedding and a diffusion model that generates the synthetic image. In some examples, an image encoder and a text encoder are trained separately from the object encoder and the diffusion model.

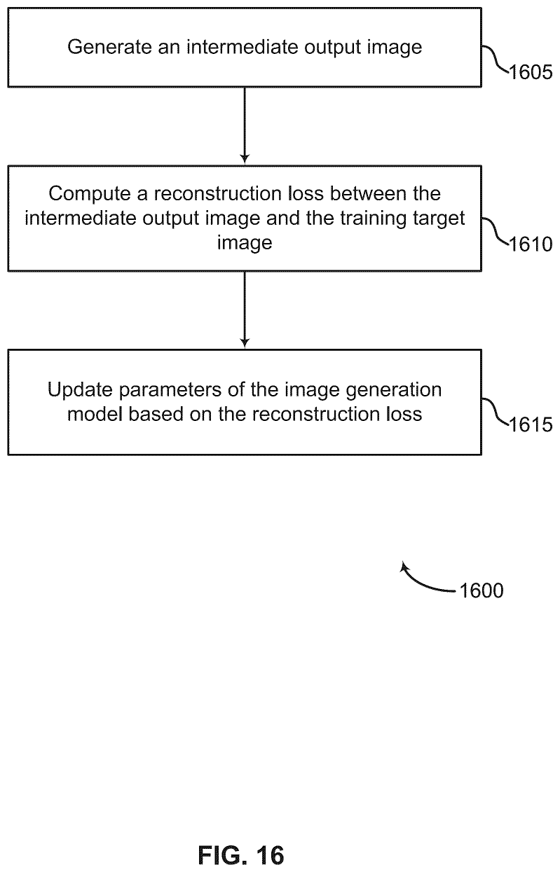

FIG. 16 shows an example of a method 1600 for training a machine learning model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1605, the system generates an intermediate output image via a diffusion model. In some cases, the operations of this step refer to, or may be performed by, a training component as described with reference to FIG. 9.

At operation 1610, the system computes a reconstruction loss between the intermediate output image and the training target image. In some cases, the operations of this step refer to, or may be performed by, a training component as described with reference to FIG. 9. In some cases, the training target image may also be referred to as a ground-truth image.

In some examples, a reconstruction loss is a loss function used to quantify how well a machine learning model can recreate or reconstruct input data from its internal representations. By measuring the reconstruction loss, the machine learning model is trained to generate an output that is as similar as possible to the input. In some examples, diffusion models can be trained using a reconstruction loss. Diffusion models involve a forward process, where data is corrupted with noise, and a reverse process, where the model learns to denoise the data step-by-step to reconstruct the original data. The reconstruction loss is used to quantify how well a diffusion model can reverse this corruption process and regenerate data that closely resembles the original input.

At operation 1615, the system updates parameters of the image generation model based on the reconstruction loss. In some cases, the operations of this step refer to, or may be performed by, a training component as described with reference to FIG. 9.

FIG. 17 shows an example of a method 1700 for training a diffusion model according to aspects of the present disclosure. In some embodiments, the method 1700 describes an operation of the training component 950 described for configuring the image generation model 925 as described with reference to FIG. 9. The method 1700 represents an example for training a reverse diffusion process as described above with reference to FIG. 12.

In some examples, these operations are performed by a system including a processor executing a set of codes to control functional elements of an apparatus, such as the guided diffusion model described in FIG. 12.

Additionally or alternatively, certain processes of method 1700 may be performed using special-purpose hardware. Generally, these operations are performed according to the methods and processes described in accordance with aspects of the present disclosure. In some cases, the operations described herein are composed of various substeps, or are performed in conjunction with other operations.

At operation 1705, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1710, the system adds noise to a media item using a forward diffusion process in N stages. In some cases, the forward diffusion process is a fixed process where Gaussian noise is successively added to media item. In latent diffusion models, the Gaussian noise may be successively added to features in a latent space.

At operation 1715, the system at each stage n, starting with stage N, a reverse diffusion process is used to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 1720, the system compares predicted output (or features) at stage n−1 to an actual media item (or features), such as the output at stage n−1 or the original input. For example, given observed data x, the diffusion model may be trained to minimize the variational upper bound of the negative log-likelihood-log pe (x) of the training data.

At operation 1725, the system updates parameters of the model based on the comparison. For example, parameters of a U-Net may be updated using gradient descent. Time-dependent parameters of the Gaussian transitions can also be learned.

FIG. 18 shows an example of training a machine learning model according to aspects of the present disclosure. FIG. 18 shows a flow diagram depicting an algorithm as a step-by-step procedure 1800 in an example implementation of operations performable for training a machine-learning model. In some embodiments, the procedure 1800 describes an operation of the training component 950 described for configuring the image generation model 925 as described with reference to FIG. 9. The procedure 1800 provides one or more examples of generating training data, use of the training data to train a machine-learning model, and use of the trained machine-learning model to perform a task.

To begin in this example, a machine-learning system collects training data (block 1802) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1804) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

To train the machine-learning model in the illustrated example, the machine-learning model is first initialized (block 1806). Initialization of the machine-learning model includes selecting a model architecture (block 1808) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1810). The loss function is utilized to measure a difference between an output of the machine-learning model (i.e., predictions) and target values (e.g., as expressed by the training data) to be used to train the machine-learning model. Additionally, an optimization algorithm is selected (1812) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1814) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1818) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1820), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1820), the procedure 1800 continues training of the machine-learning model using the training data (block 1818) in this example.

If the stopping criterion is met (“yes” from decision block 1820), the trained machine-learning model is then utilized to generate an output based on subsequent data (block 1822). The trained machine-learning model, for instance, is trained to perform a task as described above and therefore once trained is configured to perform that task based on subsequent data received as an input and processed by the machine-learning model.

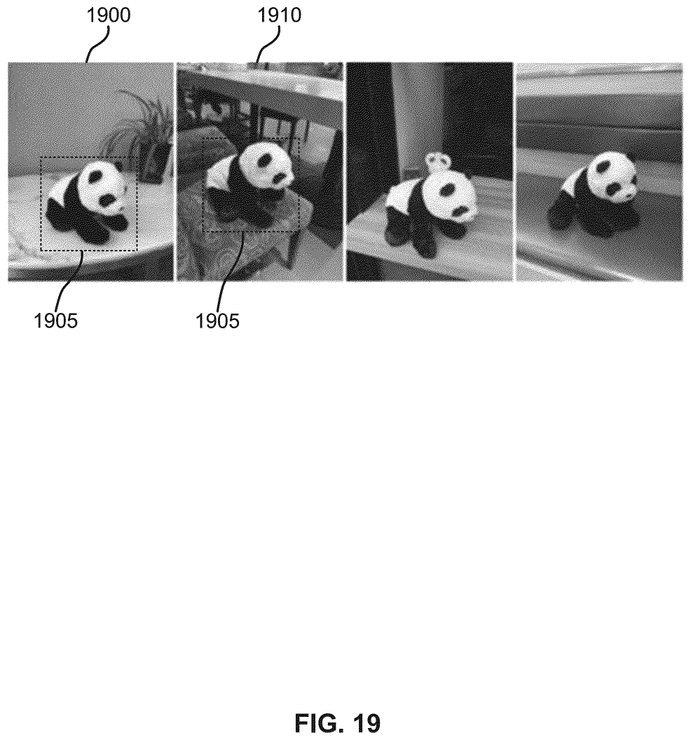

FIG. 19 shows an example of preliminary training images according to aspects of the present disclosure. The example shown includes first training image 1900, target object 1905, and second training image 1910.

First training image 1900 depicts a scene including target object 1905, which is a plush toy panda. Second training image 1910 depicts a scene including the same target object 1905 (the plush toy panda) having a different angle, view and/or pose. First training image 1900, second training image 1910 and other images in the same row are used to train image generation model 925 as described in FIG. 9.

In some cases, first training image 1900 and second training image 1910 include a same object with different camera view, on different surface and with different lighting conditions. A foreground object extraction model may extract a foreground object out (e.g., plush toy panda) and put the foreground object on a black background for training and calculating an identity score (e.g., DINO score).

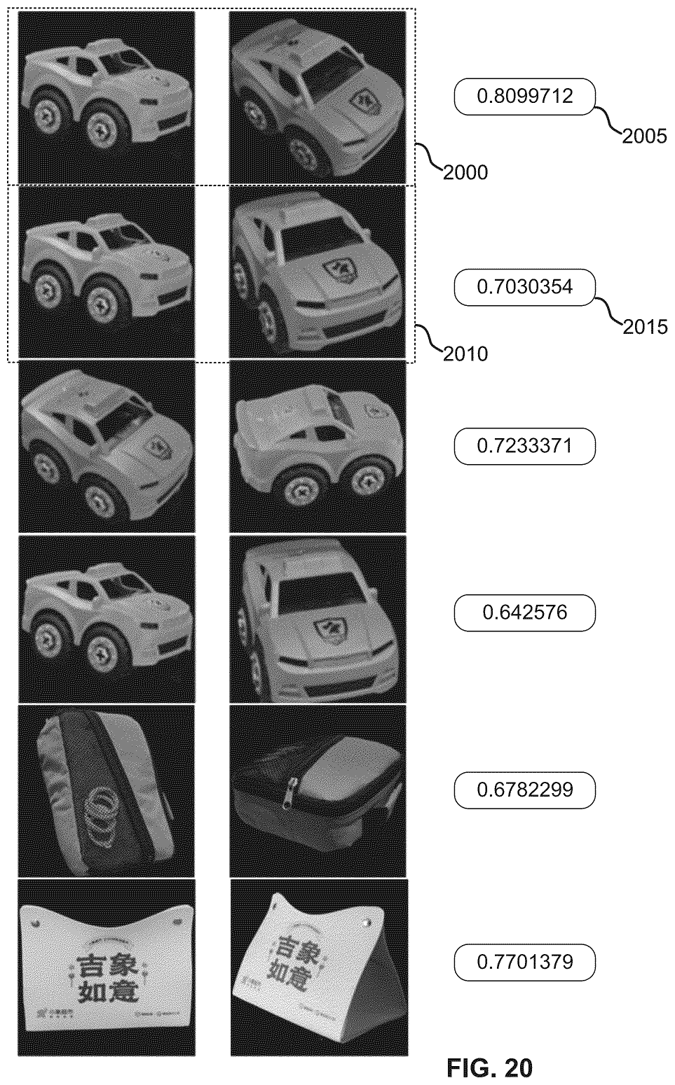

FIG. 20 shows an example of dataset according to aspects of the present disclosure. The example shown includes first training pair 2000, first identity score 2005, second training pair 2010, and second identity score 2015.

First training pair 2000 includes a pair of toy car images having different angle, pose, and/or view. First training pair 2000 is used to train image generation model 925 as described in FIG. 9 to recognize a target object with variations in viewpoint. The first identity score 2005 is calculated for first training pair 2000, which has an identity score of 0.8099712 between the pair of images.

The identity score (e.g., DINO score) can guide the image generation model to generate images with certain flexibility with the identity of the object provided in a reference image. The flexibility is in relation to the overall identity of the object and the pose and view angle of the object. In some embodiments, the image generation model segments out the foreground object mask and then conducts tightly crop over the foreground object. An identity encoder (e.g., DINO encoder) extracts image features of the two images, and then computes a cosine similarity between the image features. The cosine similarity may be referred to as an identity score.

Second training pair 2010 includes a pair of toy car images having different view and angles. Second identity score 2015 is computed for second training pair 2010. Second identity score 2015 is 0.7030354 for the pair of images. Additional training pairs are shown in other rows of FIG. 20 and the additional training pairs have their corresponding identity scores, respectively. The training pairs include images of different objects, such as a bag and a sign.

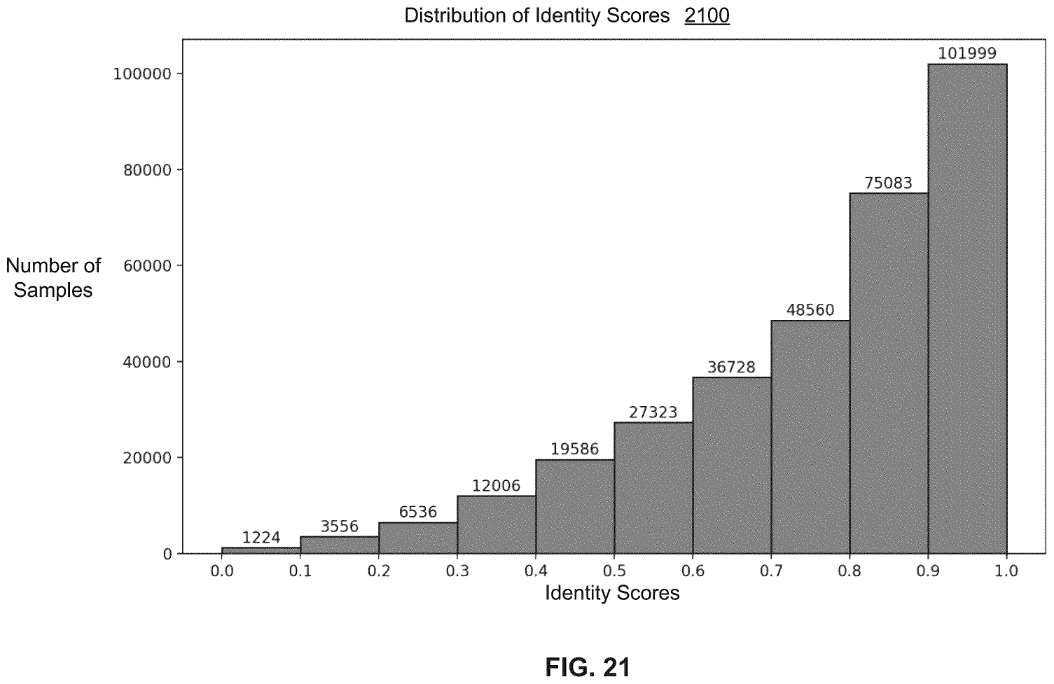

FIG. 21 shows an example of a distribution chart 2100 according to aspects of the present disclosure. Distribution chart 2100 shows a distribution of identity scores in a training dataset. The identity score is an exponential distribution in the training dataset. In some cases, training process includes filtering out image pairs having an identity score less than 0.3 to reduce the data noise.

The distribution chart 2100 illustrates the frequency of various identity scores, showing the number of samples for each score range. The distribution helps in understanding the dataset's characteristics and the effectiveness of identity preservation enabled by the image generation model.

In FIGS. 15-21, a method, apparatus, and non-transitory computer readable medium for image generation are described. One or more embodiments of the method, apparatus, and non-transitory computer readable medium include obtaining a training set including a training input image, a training target image, and a training transform input, wherein the training target image depicts an object from the training input image with a target level of a transformation indicated by the training transform input and training, using the training set, an image generation model to generate an object embedding that represents the object with the target level of the transformation and to generate a synthetic image based on the object embedding, wherein the synthetic image depicts the object with the target level of the transformation.

Some examples of the method, apparatus, and non-transitory computer readable medium further include obtaining a preliminary image. Some examples further include removing a background from the preliminary image to obtain the training input image.

Some examples of the method, apparatus, and non-transitory computer readable medium further include jointly training an object encoder that generates the object embedding and a diffusion model that generates the synthetic image.

Some examples of the method, apparatus, and non-transitory computer readable medium further include obtaining a preliminary image. Some examples further include applying an image transformation to the preliminary image to obtain the training input image.

Some examples of the method, apparatus, and non-transitory computer readable medium further include generating an intermediate output image. Some examples further include computing a reconstruction loss between the intermediate output image and the training target image. Some examples further include updating parameters of the image generation model based on the reconstruction loss.

FIG. 22 shows an example of a computing device 2200 for image generation according to aspects of the present disclosure. The computing device 2200 may be an example of the image generation apparatus 900 described with reference to FIG. 9. In one aspect, computing device 2200 includes processor(s) 2205, memory subsystem 2210, communication interface 2215, I/O interface 2220, user interface component(s) 2225, and channel 2230.

In some embodiments, computing device 2200 is an example of, or includes aspects of, the image generation model of FIG. 9. In some embodiments, computing device 2200 includes one or more processors 2205 that can execute instructions stored in memory subsystem 2210 to perform media generation.

According to some aspects, computing device 2200 includes one or more processors 2205. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 2210 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 2215 operates at a boundary between communicating entities (such as computing device 2200, one or more user devices, a cloud, and one or more databases) and channel 2230 and can record and process communications. In some cases, communication interface 2215 is provided to enable a processing system coupled to a transceiver (e.g., a transmitter and/or a receiver). In some examples, the transceiver is configured to transmit (or send) and receive signals for a communications device via an antenna.

According to some aspects, I/O interface 2220 is controlled by an I/O controller to manage input and output signals for computing device 2200. In some cases, I/O interface 2220 manages peripherals not integrated into computing device 2200. In some cases, I/O interface 2220 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 2220 or via hardware components controlled by the I/O controller.

According to some aspects, user interface component(s) 2225 enable a user to interact with computing device 2200. In some cases, user interface component(s) 2225 include an audio device, such as an external speaker system, an external display device such as a display screen, an input device (e.g., a remote-control device interfaced with a user interface directly or through the I/O controller), or a combination thereof. In some cases, user interface component(s) 2225 include a GUI.

Performance of apparatus, systems and methods of the present disclosure have been evaluated, and results indicate embodiments of the present disclosure have obtained increased performance over existing technology. Example experiments demonstrate that the image generation apparatus described in embodiments of the present disclosure outperforms conventional systems.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an input prompt, a reference image, and a transform input, wherein the input prompt describes a scene, the reference image depicts an object, and the transform input indicates a target level of a transformation for the object;
generating, using an object encoder of an image generation model, an object embedding based on the reference image and the transform input, wherein the object embedding represents the object and the target level of the transformation; and
generating, using the image generation model, a synthetic image based on the input prompt and the object embedding, wherein the synthetic image depicts the object in the scene from the input prompt with the target level of the transformation.

2. The method of claim 1, wherein obtaining the reference image comprises:
obtaining a preliminary image depicting the object; and
removing a background from the preliminary image to obtain the reference image.

3. The method of claim 1, wherein generating the object embedding comprises:
generating a preliminary embedding representing the object; and
transforming the preliminary embedding based on the transform input to obtain the object embedding.

4. The method of claim 3, further comprising:
encoding the transform input to obtain a projection vector, wherein the preliminary embedding is transformed based on the projection vector.

5. The method of claim 1, wherein generating the synthetic image comprises:
obtaining a noise map; and
denoising the noise map based on the object embedding.

6. The method of claim 1, further comprising:
encoding the input prompt to obtain a text embedding, wherein the synthetic image is generated based on the text embedding.

7. The method of claim 1, further comprising:
obtaining an additional reference image depicting the scene; and
encoding the additional reference image to obtain a reference embedding, wherein the synthetic image is generated based on the reference embedding.

8. The method of claim 1, wherein:
the transform input includes a size parameter, an identity parameter, or both.

9. The method of claim 8, wherein:
the identity parameter indicates a pose of the object, a view angle of the object, or both.

10. The method of claim 8, wherein:
the size parameter indicates a target scale of the object relative to the reference image.

11. The method of claim 1, wherein:
the transform input indicates a target level of identity preservation for the object.

12. A method comprising:
obtaining a training set including a training input image, a training target image, and a training transform input, wherein the training target image depicts an object from the training input image with a target level of a transformation indicated by the training transform input; and
training, using the training set, an image generation model to generate an object embedding that represents the object with the target level of the transformation and to generate a synthetic image based on the object embedding, wherein the synthetic image depicts the object with the target level of the transformation.

13. The method of claim 12, wherein training the image generation model comprises:
jointly training an object encoder that generates the object embedding and a diffusion model that generates the synthetic image.

14. The method of claim 12, wherein obtaining the training set comprises:
obtaining a preliminary image; and
applying an image transformation to the preliminary image to obtain the training input image.

15. The method of claim 12, wherein training the image generation model comprises:
generating an intermediate output image;
computing a reconstruction loss between the intermediate output image and the training target image; and
updating parameters of the image generation model based on the reconstruction loss.

16. An apparatus comprising:
at least one processor;
at least one memory including instructions executable by the at least one processor; and
an image generation model comprising parameters stored in the at least one memory and trained to receive an input prompt, a reference image, and a transform input, wherein the input prompt describes a scene, the reference image depicts an object, and the transform input indicates a target level of a transformation for the object, to generate an object embedding based on the reference image and the transform input, wherein the object embedding represents the object and the target level of the transformation, and to generate a synthetic image based on the input prompt and the object embedding, wherein the synthetic image depicts the object in the scene from the input prompt with the target level of the transformation.

17. The apparatus of claim 16, wherein:
the image generation model comprises an object encoder trained to generate the object embedding.

18. The apparatus of claim 16, further comprising:
the image generation model comprises a diffusion model trained to generate the synthetic image.

19. The apparatus of claim 16, further comprising:
a text encoder configured to encode the input prompt to obtain a text embedding, wherein the synthetic image is generated based on the text embedding.

20. The apparatus of claim 16, further comprising:
an image encoder configured to encode an additional reference image to obtain a reference embedding, wherein the synthetic image is generated based on the reference embedding.
